(19) United States
(12) Patent Application Publication
(10) Pub. No.: US 2022/0225276 A1
(43) Pub. Date: Jul. 14, 2022

(54) COMMUNICATION METHOD AND DEVICE

(71) Applicant: HUAWEI TECHNOLOGIES CO., LTD., Shenzhen (CN)

(72) Inventors: Shengfeng Xu, Beijing (CN); Jiangwei Ying, Beijing (CN); Yanmei Yang, Beijing (CN)

(73) Assignee: HUAWEI TECHNOLOGIES CO., LTD., Shenzhen (CN)

(21) Appl. No.: 17/707,717

(22) Filed: Mar. 29, 2022

Related U.S. Application Data
(63) Continuation of application No. PCT/CN2019/109219, filed on Sep. 29, 2019.

(51) Int. Cl. H04W 68/02

(52) U.S. Cl. CPC H04W 68/02; H04W 88/06

(57) ABSTRACT

A communication method and device are provided. A terminal device receives a paging message carrying first service information of a first service from an AMF network element, where the paging message corresponds to a first USIM in at least two USIMs of the terminal device; and sends a response message of the paging message to the AMF network element based on the first service information and service information of a second service, where the second service is a current service of a second USIM of the terminal device, and the second USIM is in connected state. In embodiments of the present invention, responding to the paging message is determined based on service information of a service instead of blindly responding to the paging message, to avoid suspending the service of the USIM currently in the connected state on the terminal device once the paging message is received.

### CROSS-REFERENCE TO RELATED APPLICATIONS

This application is a continuation of International Application No. PCT/CN2019/109219, filed on Sep. 29, 2019, which is hereby incorporated by reference in their entireties.

### TECHNICAL FIELD

Embodiments of the present invention relate to the field of communication technologies, and in particular, to a communication method and device.

### BACKGROUND

When two receivers and one transmitter are disposed in a terminal device, the terminal device supports two universal subscriber identity modules (USIMs). When the two USIMs are in an idle state, both the USIMs can receive network paging. When one USIM is in a connected state, the other USIM may use the other receiver to receive network paging.

However, when one USIM is in the connected state, after a paging message for the other USIM is received, service data of the USIM is suspended when the terminal device responds to the paging message, or a service corresponding to the paging message is rejected when the terminal device does not respond to the paging message. Therefore, how the terminal device determines whether to respond to the paging message has become a technical problem to be urgently resolved.

### SUMMARY

Embodiments of the present disclosure disclose a communication method and device, to determine, based on service information, of a service, carried in a paging message, whether to respond to the paging message.

According to a first aspect, a communication method is disclosed. A terminal device receives a paging message carrying first service information of a first service from an access and mobility management function (AMF) network element, and sends a response message of the paging message to the AMF network element based on the first service information of the first service and service information of a second service. The paging message corresponds to a first USIM in at least two USIMs of the terminal device, the second service is a current service of a second USIM of the terminal device, and the second USIM is in a connected state. It can be learned that the terminal device may determine, based on service information, of a service, carried in the paging message and service information of a service of the USIM currently in the connected state on the terminal device, whether to respond to the paging message instead of blindly responding to the paging message, to avoid suspending the service of the USIM currently in the connected state on the terminal device once the paging message is received.

In a possible implementation, the first service information of the first service may include a priority of the first service, may include service type information of the first service, or may include at least one of a 5G quality of service (QoS) flow identifier (5G QoS identifier, 5QI), a differentiated services code point (DSCP), and a QoS flow identifier (QFI) of the first service.

In a possible implementation, when the terminal device determines, based on the first service information of the first service and the service information of the second service, that the priority of the first service is higher than a priority of the second service, the terminal device sends the response message of the paging message to the AMF network element. It can be learned that the terminal device responds to the paging message only when a priority, of the service, carried in the paging message received by the terminal device is higher than a priority of the service of the USIM currently in the connected state on the terminal device, to ensure that a service with a high priority is processed first, and therefore ensure that an important service is processed first.

In a possible implementation, when the first service information of the first service does not include the priority of the first service, and the service information of the second service includes the priority of the second service, the terminal device may first obtain the priority of the first service based on the first service information of the first service, and then determine that the priority of the first service is higher than the priority of the second service.

In a possible implementation, when the first service information of the first service includes the at least one of the 5QI, the DSCP, and the QFI of the first service, the terminal device may first obtain the service type information of the first service based on the first service information of the first service, and then obtain the priority of the first service based on the service type information of the first service.

In a possible implementation, the terminal device may send, to the AMF network element, indication information used to indicate to include service information of a service in the paging message sent to the terminal device, so that the terminal device may determine, based on the service information, of the service, carried in the paging message, whether to respond to the paging message. Alternatively, the terminal device may send, to the AMF network element, USIM capability information that is of the terminal device and that is used to indicate that the terminal device supports at least two USIMs, so that the AMF network element may include the service information of the service in the paging message based on the USIM capability information.

According to a second aspect, a communication method is disclosed. A terminal device may send, to an AMF network element, service priority information that is of the terminal device and that is used to indicate a priority of a service, so that the AMF network element may determine, based on the service priority information of the service, whether to include service information of the service in a paging message.

In a possible implementation, the terminal device may send service information of a second service to the AMF network element, where the second service is a current service of a second USIM in at least two USIMs of the terminal device, and the second USIM is in a connected state, so that the AMF network element may determine, based on the service priority information of the service and service information of a service of the USIM currently in the connected state on the terminal device, whether to send the paging message and whether to include the service information of the service in the paging message.

In a possible implementation, when the current service includes at least two services, the second service is a service with a highest priority in the at least two services, and an amount of reported information may be reduced without affecting a function of the reported information.

In a possible implementation, the terminal device may send, to the AMF network element, a paging-restricted indication used to indicate not to send a paging message to a first USIM, so that the AMF network element may not send the paging message to the first USIM of the terminal device based on the paging-restricted indication, and a quantity of messages may be reduced. Therefore, transmission resources can be saved. The first USIM is any USIM in an idle state in the at least two USIMs of the terminal device.

In a possible implementation, the paging-restricted indication may carry an identifier of the first USIM, so that the first USIM to which the paging message is not sent may be determined based on the identifier.

In a possible implementation, when a second service has a highest priority in services supported by the terminal device, the terminal device sends the paging-restricted indication to the AMF network element, where the second service is a current service of a second USIM in at least two USIMs of the terminal device, and the second USIM is in a connected state. It can be learned that when the service of the USIM currently in the connected state on the terminal device is a service with a highest priority in services supported by the terminal device, the paging-restricted indication may be sent to the AMF network element, so that impact of the paging message on an important service can be avoided, and transmission of unnecessary messages can be reduced, thereby saving transmission resources.

In a possible implementation, when the second service ends, the terminal device may send, to the AMF network element, a paging-restricted cancellation indication used to indicate to cancel the paging-restricted indication, so that the AMF network element may resend the paging message to the first USIM of the terminal device.

In a possible implementation, the service information of the second service may include a priority of the second service, may include service type information of the second service, or may include at least one of a 5QI, a DSCP, and a QFI of the second service.

According to a third aspect, a communication method is disclosed. A user plane function (user plane function, UPF) network element receives first indication information from a session management function (session management function, SMF) network element, and sends a first data notification message to the SMF network element based on the first indication information. The first indication information is used to indicate to include service information in a data notification message of a first USIM, or is used to indicate to include service information in a data notification message when to-be-sent downlink data for a first USIM is data of a specific service. The first data notification message is used to notify that there is the to-be-sent downlink data for the first USIM, and the first data notification message carries second service information of a first service corresponding to the to-be-sent downlink data for the first USIM. The UPF network element may include service information of a service in a data notification message based on indication information, so that an AMF network element can include the service information of the service in a paging message.

In a possible implementation, the second service information of the first service may include a priority of the first service, may include service type information of the first service, or may include at least one of a 5QI, a DSCP, and a QFI of the first service.

According to a fourth aspect, a communication method is disclosed. An SMF network element receives a first data notification message from a UPF network element, and sends a second data notification message to an AMF network element based on the first data notification message. The first data notification message is used to notify that there is to-be-sent downlink data for a first USIM, and the first data notification message carries second service information of a first service corresponding to the to-be-sent downlink data for the first USIM. The second data notification message carries the second service information of the first service corresponding to the to-be-sent downlink data for the first USIM. The SMF network element may include, based on the service information, of the service, carried in the data notification message sent by the UPF network element, the service information of the service in the data notification message sent to the AMF network element, so that the AMF network element can include the service information of the service in a paging message.

In a possible implementation, the SMF network element may send first indication information to the UPF network element, where the first indication information is used to indicate to include the service information in a data notification message of the first USIM, or is used to indicate to include the service information in a data notification message when the to-be-sent downlink data for the first USIM is data of a specific service. The SMF network element may send the indication information to indicate the UPF network element to include the service information of the service in the sent data notification message, so that the first data notification message sent by the UPF network element to the SMF network element carries the service information of the service. The second data notification message sent by the SMF network element to the AMF network element carries the service information of the service, so that the AMF network element can include the service information of the service in the paging message.

In a possible implementation, the SMF network element may receive the first indication information from a policy control function (PCF) network element, or may receive the first indication information from a unified data management (UDM) network element.

In a possible implementation, the SMF network element may receive USIM capability information of a terminal device, and send the first indication information to the UPF network element based on the USIM capability information of the terminal device. The USIM capability information is used to indicate that the terminal device supports at least two USIMs, and the first USIM is a USIM corresponding to the terminal device.

In a possible implementation, the second service information of the first service may include a priority of the first service, may include service type information of the first service, or may include at least one of a 5QI, a DSCP, and a QFI of the first service.

According to a fifth aspect, a communication method is disclosed. An AMF network element receives a second data notification message carrying second service information of a first service corresponding to to-be-sent downlink data for a first USIM from an SMF network element, and sends a paging message to a terminal device based on the second data notification message. The first USIM is a USIM corresponding to the terminal device, the paging message is used to page a user corresponding to the first USIM, and the paging message carries first service information of the first service. It can be learned that when a data notification message delivered by the SMF network element carries service information of a service, the paging message carries the service information of the service, so that the terminal device may determine, based on the service information of the service, whether to respond to the paging message.

In a possible implementation, when the first service information of the first service is different from the second service information of the first service, the AMF network element may obtain the first service information of the first service based on the second service information of the first service.

In a possible implementation, the second service information of the first service does not include a priority of the first service, and the first service information of the first service includes the priority of the first service. The AMF network element may receive service priority information of the terminal device, and obtain the first service information of the first service based on the second service information of the first service and the service priority information of the terminal device.

In a possible implementation, the AMF network element receives service information of a second service from the terminal device, and sends the paging message to the terminal device based on the second service information of the first service and the service information of the second service. The second service is a current service of a second USIM of the terminal device, and the second USIM is in a connected state. It can be learned that the AMF network element may determine, based on service information of a to-be-sent service and service information of a service of the USIM currently in the connected state on the terminal device, whether to send the paging message to the terminal device instead of blindly sending the paging message, to avoid an unnecessary paging message, thereby saving transmission resources.

In a possible implementation, the AMF network element sends the paging message to the terminal device when the AMF network element determines, based on the second service information of the first service and the service information of the second service, that the priority of the first service is higher than a priority of the second service. It can be learned that the paging message is sent only when a priority of the to-be-sent service is higher than a priority of the service of the USIM currently in the connected state on the terminal device, to ensure that a service with a high priority is processed first, and therefore ensure that an important service is processed first.

In a possible implementation, the AMF network element receives the service priority information of the terminal device, and the AMF network element determines, based on the service priority information, the second service information of the first service, and the service information of the second service, that the priority of the first service is higher than the priority of the second service.

In a possible implementation, the AMF network element receives, from the terminal device, indication information used to indicate to include service information of a service in the paging message that corresponds to the first USIM and is sent to the terminal device, and sends the paging message to the terminal device based on the indication information.

In a possible implementation, the AMF network element receives USIM capability information used to indicate that the terminal device supports at least two USIMs from the terminal device, and sends the paging message to the terminal device based on the USIM capability information.

In a possible implementation, the second service information of the first service may include a priority of the first service, may include service type information of the first service, or may include at least one of a 5QI, a DSCP, and a QFI of the first service.

In a possible implementation, the first service information of the first service may include the priority of the first service, may include the service type information of the first service, or may include the at least one of the 5QI, the DSCP, and the QFI of the first service.

According to a sixth aspect, a communication method is disclosed. An AMF network element receives a second data notification message from an SMF network element, where the second data notification message carries second service information of a first service corresponding to to-be-sent downlink data for a first USIM, and the first USIM is a USIM corresponding to a terminal device.

In a possible implementation, the AMF network element may receive a paging-restricted indication from the terminal device, and determine, based on the paging-restricted indication, not to send the paging message to the first USIM. The paging-restricted indication is used to indicate not to send the paging message to the first USIM, and the first USIM is in an idle state. The AMF network element may not send the paging message to the first USIM of the terminal device based on the paging-restricted indication, and a quantity of messages may be reduced. Therefore, transmission resources can be saved.

According to a seventh aspect, a terminal device is disclosed, including:

a receiving unit, configured to receive a paging message from an AMF network element, where the paging message corresponds to a first USIM in at least two USIMs of the terminal device, and the paging message carries first service information of a first service; and

a sending unit, configured to send a response message of the paging message to the AMF network element based on the first service information of the first service and service information of a second service, where the second service is a current service of a second USIM of the terminal device, and the second USIM is in a connected state.

In a possible implementation, the first service information of the first service includes:

a priority of the first service;

service type information of the first service; or

at least one of a 5QI, a DSCP, and a QFI of the first service.

In a possible implementation, the sending unit is specifically configured to: when determining, based on the first service information of the first service and the service information of the second service, that the priority of the first service is higher than a priority of the second service, send the response message of the paging message to the AMF network element.

In a possible implementation, when the first service information of the first service does not include the priority of the first service, and the service information of the second service includes the priority of the second service, that the sending unit determines, based on the first service information of the first service and the service information of the second service, that the priority of the first service is higher than a priority of the second service includes:

obtaining the priority of the first service based on the first service information of the first service; and

determining that the priority of the first service is higher than the priority of the second service.

In a possible implementation, when the first service information of the first service includes the at least one of the 5QI, the DSCP, and the QFI of the first service, that the sending unit obtains the priority of the first service based on the first service information of the first service includes:

obtaining the service type information of the first service based on the first service information of the first service; and

obtaining the priority of the first service based on the service type information of the first service.

In a possible implementation, the sending unit is further configured to:

send indication information to the AMF network element, where the indication information is used to indicate to include service information of a service in the paging message sent to the terminal device; or

send USIM capability information of the terminal device to the AMF network element, where the USIM capability information is used to indicate that the terminal device supports at least two USIMs.

According to an eighth aspect, a terminal device is disclosed, including:

a sending unit, configured to send service priority information of the terminal device to an AMF network element, where the service priority information is used to indicate a priority of a service.

In a possible implementation, the sending unit is further configured to send service information of a second service to the AMF network element, where the second service is a current service of a second USIM in at least two USIMs of the terminal device, and the second USIM is in a connected state.

In a possible implementation, when the current service includes at least two services, the second service is a service with a highest priority in the at least two services.

In a possible implementation, the sending unit is further configured to send a paging-restricted indication to the AMF network element, where the paging-restricted indication is used to indicate not to send a paging message to a first USIM, and the first USIM is any USIM in an idle state in the at least two USIMs of the terminal device.

In a possible implementation, the paging-restricted indication carries an identifier of the first USIM.

In a possible implementation, that the sending unit sends a paging-restricted indication to the AMF network element includes:

when a second service has a highest priority in services supported by the terminal device, sending the paging-restricted indication to the AMF network element, where the second service is a current service of a second USIM in at least two USIMs of the terminal device, and the second USIM is in a connected state.

In a possible implementation, the sending unit is further configured to: when the second service ends, send a paging-restricted cancellation indication to the AMF network element, where the paging-restricted cancellation indication is used to indicate to cancel the paging-restricted indication.

In a possible implementation, the service information of the second service includes:

a priority of the second service;

service type information of the second service; or

at least one of a 5QI, a DSCP, and a QFI of the second service.

According to a ninth aspect, a UPF network element is disclosed, including:

a receiving unit, configured to receive first indication information from an SMF network element, where the first indication information is used to indicate to include service information in a data notification message of a first USIM, or is used to indicate to include service information in a data notification message when to-be-sent downlink data for a first USIM is data of a specific service; and

a sending unit, configured to send a first data notification message to the SMF network element based on the first indication information, where the first data notification message is used to notify that there is the to-be-sent downlink data for the first USIM, and the first data notification message carries second service information of a first service corresponding to the to-be-sent downlink data for the first USIM.

In a possible implementation, the second service information of the first service includes:

a priority of the first service;

service type information of the first service; or

at least one of a 5QI, a DSCP, and a QFI of the first service.

According to a tenth aspect, an SMF network element is disclosed, including:

a receiving unit, configured to receive a first data notification message from a UPF network element, where the first data notification message is used to notify that there is to-be-sent downlink data for a first USIM, and the first data notification message carries second service information of a first service corresponding to the to-be-sent downlink data for the first USIM; and

a sending unit, configured to send a second data notification message to an AMF network element based on the first data notification message, where the second data notification message carries the second service information of the first service corresponding to the to-be-sent downlink data for the first USIM.

In a possible implementation, the sending unit is further configured to send first indication information to the UPF network element, where the first indication information is used to indicate to include service information in a data notification message of the first USIM, or is used to indicate to include service information in a data notification message when the to-be-sent downlink data for the first USIM is data of a specific service.

In a possible implementation, the receiving unit is further configured to receive the first indication information from a PCF network element or a UDM network element.

In a possible implementation, the receiving unit is further configured to receive USIM capability information from a terminal device, where the USIM capability information is used to indicate that the terminal device supports at least two USIMs, and the first USIM is a USIM corresponding to the terminal device; and

that the sending unit sends first indication information to the UPF network element includes:

sending the first indication information to the UPF network element based on the USIM capability information of the terminal device.

In a possible implementation, the second service information of the first service includes:

a priority of the first service;

service type information of the first service; or

at least one of a 5QI, a DSCP, and a QFI of the first service.

According to an eleventh aspect, an AMF network element is disclosed, including:

a receiving unit, configured to receive a second data notification message from an SMF network element, where the second data notification message carries second service information of a first service corresponding to to-be-sent downlink data for a first USIM, and the first USIM is a USIM corresponding to a terminal device; and

a sending unit, configured to send a paging message to the terminal device based on the second data notification message, where the paging message is used to page a user corresponding to the first USIM, and the paging message carries first service information of the first service.

In a possible implementation, the AMF network element further includes:

an obtaining unit, configured to: when the first service information of the first service is different from the second service information of the first service, obtain the first service information of the first service based on the second service information of the first service.

In a possible implementation, the second service information of the first service does not include a priority of the first service, the first service information of the first service includes the priority of the first service, and the obtaining unit is specifically configured to:

receive service priority information of the terminal device; and

obtain the first service information of the first service based on the second service information of the first service and the service priority information of the terminal device.

In a possible implementation, the receiving unit is further configured to receive service information of a second service from the terminal device, where the second service is a current service of a second USIM of the terminal device, and the second USIM is in a connected state; and

that a sending unit sends a paging message to the terminal device includes:

sending the paging message to the terminal device based on the second service information of the first service and the service information of the second service.

In a possible implementation, that the sending unit sends the paging message to the terminal device based on the second service information of the first service and the service information of the second service includes:

sending the paging message to the terminal device when determining, based on the second service information of the first service and the service information of the second service, that the priority of the first service is higher than a priority of the second service.

In a possible implementation, the receiving unit is further configured to receive the service priority information of the terminal device; and

that the sending unit determines, based on the second service information of the first service and the service information of the second service, that the priority of the first service is higher than a priority of the second service includes:

determining, based on the service priority information, the second service information of the first service, and the service information of the second service, that the priority of the first service is higher than the priority of the second service.

In a possible implementation, the receiving unit is further configured to receive indication information from the terminal device, where the indication information is used to indicate to include service information of a service in the paging message that corresponds to the first USIM and is sent to the terminal device; and

that a sending unit sends a paging message to the terminal device includes:

sending the paging message to the terminal device based on the indication information.

In a possible implementation, the receiving unit is further configured to receive USIM capability information from the terminal device, where the USIM capability information is used to indicate that the terminal device supports at least two USIMs; and

that a sending unit sends a paging message to the terminal device includes:

sending the paging message to the terminal device based on the USIM capability information.

In a possible implementation, the second service information of the first service includes:

a priority of the first service;

service type information of the first service; or

at least one of a 5QI, a DSCP, and a QFI of the first service.

In a possible implementation, the first service information of the first service includes:

the priority of the first service;

the service type information of the first service; or

the at least one of the 5QI, the DSCP, and the QFI of the first service.

According to a twelfth aspect, an AMF network element is disclosed, including:

a receiving unit, configured to receive a second data notification message from an SMF network element, where the second data notification message carries second service information of a first service corresponding to to-be-sent downlink data for a first USIM, and the first USIM is a USIM corresponding to a terminal device.

In a possible implementation, the receiving unit is further configured to receive a paging-restricted indication from the terminal device, where the paging-restricted indication is used to indicate not to send a paging message to the first USIM, and the first USIM is in an idle state.

The AMF network element further includes:

a determining unit, configured to determine, based on the paging-restricted indication, not to send the paging message to the first USIM.

According to a thirteenth aspect, a terminal device is disclosed, including a processor, a memory, an input interface, and an output interface. The input interface is configured to receive information from another communication device other than the terminal device, and the output interface is configured to output information to the another communication device other than the terminal device. When the processor executes a computer program stored in the memory, the processor is enabled to perform the communication method disclosed in any one of the first aspect or the possible implementations of the first aspect.

According to a fourteenth aspect, a terminal device is disclosed, including a processor, a memory, an input interface, and an output interface. The input interface is configured to receive information from another communication device other than the terminal device, and the output interface is configured to output information to the another communication device other than the terminal device. When the processor executes a computer program stored in the memory, the processor is enabled to perform the communication method disclosed in any one of the second aspect or the possible implementations of the second aspect.

According to a fifteenth aspect, a UPF network element is disclosed, including a processor, a memory, an input interface, and an output interface. The input interface is configured to receive information from another communication device other than the UPF network element, and the output interface is configured to output information to the another communication device other than the UPF network element. When the processor executes a computer program stored in the memory, the processor is enabled to perform the communication method disclosed in any one of the third aspect or the possible implementations of the third aspect.

According to a sixteenth aspect, an SMF network element is disclosed, including a processor, a memory, an input interface, and an output interface. The input interface is configured to receive information from another communication device other than the SMF network element, and the output interface is configured to output information to the another communication device other than the SMF network element. When the processor executes a computer program stored in the memory, the processor is enabled to perform the communication method disclosed in any one of the fourth aspect or the possible implementations of the fourth aspect.

According to a seventeenth aspect, an AMF network element is disclosed, including a processor, a memory, an input interface, and an output interface. The input interface is configured to receive information from another communication device other than the AMF network element, and the output interface is configured to output information to the another communication device other than the AMF network element. When the processor executes a computer program stored in the memory, the processor is enabled to perform the communication method disclosed in any one of the fifth aspect or the possible implementations of the fifth aspect.

According to an eighteenth aspect, an AMF network element is disclosed, including a processor, a memory, an input interface, and an output interface. The input interface is configured to receive information from another communication device other than the AMF network element, and the output interface is configured to output information to the another communication device other than the AMF network element. When the processor executes a computer program stored in the memory, the processor is enabled to perform the communication method disclosed in any one of the sixth aspect or the possible implementations of the sixth aspect.

According to a nineteenth aspect, a communication system is disclosed, including the terminal device disclosed in any one of the thirteenth aspect or the possible implementations of the thirteenth aspect, the UPF network element disclosed in any one of the fifteenth aspect or the possible implementations of the fifteenth aspect, the SMF network element disclosed in any one of the sixteenth aspect or the possible implementations of the sixteenth aspect, and the AMF network element disclosed in any one of the seventeenth aspect or the possible implementations of the seventeenth aspect; the terminal device disclosed in any one of the fourteenth aspect or the possible implementations of the fourteenth aspect, the UPF network element disclosed in any one of the fifteenth aspect or the possible implementations of the fifteenth aspect, the SMF network element disclosed in any one of the sixteenth aspect or the possible implementations of the sixteenth aspect, and the AMF network element disclosed in any one of the seventeenth aspect or the possible implementations of the seventeenth aspect; or the terminal device disclosed in any one of the fourteenth aspect or the possible implementations of the fourteenth aspect, the UPF network element disclosed in any one of the fifteenth aspect or the possible implementations of the fifteenth aspect, the SMF network element disclosed in any one of the sixteenth aspect or the possible implementations of the sixteenth aspect, and the AMF network element disclosed in any one of the eighteenth aspect or the possible implementations of the eighteenth aspect.

According to a twentieth aspect, a computer storage medium is disclosed. The storage medium stores a program, and when the program is run, the communication method disclosed in any one of the first aspect or the possible implementations of the first aspect, any one of the second aspect or the possible implementations of the second aspect, any one of the third aspect or the possible implementations of the third aspect, any one of the fourth aspect or the possible implementations of the fourth aspect, any one of the fifth aspect or the possible implementations of the fifth aspect, or any one of the sixth aspect or the possible implementations of the sixth aspect is implemented.

### BRIEF DESCRIPTION OF DRAWINGS

FIG. 1 is a schematic diagram of a network architecture according to an embodiment of the present invention;

FIG. 2 is a schematic diagram of another network architecture according to an embodiment of the present invention;

FIG. 3 is a schematic diagram of a terminal device with two USIMs according to an embodiment of the present invention;

FIG. 4 is a schematic diagram of paging of DSDS dual receivers in a DSDS mode according to an embodiment of the present invention;

FIG. 5 is a schematic flowchart of a communication method according to an embodiment of the present invention;

FIG. 6 is a schematic flowchart of another communication method according to an embodiment of the present invention;

FIG. 7 is a schematic flowchart of still another communication method according to an embodiment of the present invention;

FIG. 8 is a schematic flowchart of still another communication method according to an embodiment of the present invention;

FIG. 9 is a schematic flowchart of still another communication method according to an embodiment of the present invention;

FIG. 10 is a schematic flowchart of still another communication method according to an embodiment of the present invention;

FIG. 11 is a schematic diagram of a structure of a terminal device according to an embodiment of the present invention;

FIG. 12 is a schematic diagram of a structure of another terminal device according to an embodiment of the present invention;

FIG. 13 is a schematic diagram of a structure of a UPF network element according to an embodiment of the present invention;

FIG. 14 is a schematic diagram of a structure of an SMF network element according to an embodiment of the present invention;

FIG. 15 is a schematic diagram of a structure of an AMF network element according to an embodiment of the present invention;

FIG. 16 is a schematic diagram of a structure of another AMF network element according to an embodiment of the present invention;

FIG. 17 is a schematic diagram of a structure of a communication device according to an embodiment of the present invention; and

FIG. 18 is a schematic diagram of a structure of another communication device according to an embodiment of the present invention.

### DESCRIPTION OF EMBODIMENTS

Embodiments of the present invention disclose a communication method and device, to determine, based on service information, of a service, corresponding to a paging message, whether to respond to the paging message. Details are separately described in the following.

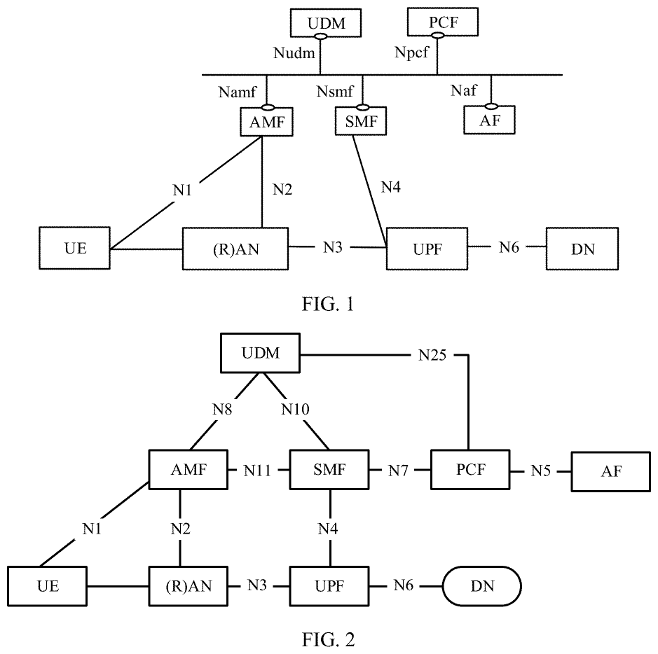

For better understanding the communication method and device disclosed in embodiments of the present invention, the following first describes a network architecture used in embodiments of the present invention. FIG. 1 is a schematic diagram of a network architecture according to an embodiment of the present invention. As shown in FIG. 1, the network architecture may include a terminal device, a (radio) access network ((R)AN) device, a UPF network element, a data network (DN), an AMF network element, an SMF network element, a PCF network element, an application function (AF) network element, and a UDM network element.

The terminal device may directly communicate with the (R)AN device. There is a communication interface between the terminal device and the AMF network element, and the communication interface may be an N1 interface. There is a communication interface between the (R)AN device and the AMF network element, and the communication interface may be an N2 interface. There is a communication interface between the (R)AN device and the UPF network element, and the communication interface may be an N3 interface. There is a communication interface between the UPF network element and the DN, and the communication interface may be an N6 interface. There is a communication interface between the UPF network element and the SMF network element, and the communication interface may be an N4 interface. The AMF network element may provide a service-oriented interface Namf, the SMF network element may provide a service-oriented interface Nsmf, the PCF network element may provide a service-oriented interface Npcf, the AF network element may provide a service-oriented interface Naf, and the UDM network element may provide a service-oriented interface Nudm. The AMF network element, the SMF network element, the PCF network element, the AF network element, and the UDM network element may communicate with each other through service-oriented interfaces.

FIG. 2 is a schematic diagram of another network architecture according to an embodiment of the present invention. As shown in FIG. 2, the network architecture may include a terminal device, a (R)AN device, a UPF network element, a DN, an AMF network element, an SMF network element, a PCF network element, an AF network element, and a UDM network element. The terminal device may directly communicate with the (R)AN device. There is a communication interface between the terminal device and the AMF network element, and the communication interface may be an N1 interface. There is a communication interface between the (R)AN device and the AMF network element, and the communication interface may be an N2 interface. There is a communication interface between the (R)AN device and the UPF network element, and the communication interface may be an N3 interface. There is a communication interface between the UPF network element and the DN, and the communication interface may be an N6 interface. There is a communication interface between the UPF network element and the SMF network element, and the communication interface may be an N4 interface. There is a communication interface between the AMF network element and the SMF network element, and the communication interface may be an N11 interface. There is a communication interface between the AMF network element and the UDM network element, and the communication interface may be an N8 interface. There is a communication interface between the SMF network element and the UDM network element, and the communication interface may be an N10 interface. There is a communication interface between the SMF network element and the PCF network element, and the communication interface may be an N7 interface. There is a communication interface between the PCF network element and the UDM network element, and the communication interface may be an N25 interface. There is a communication interface between the PCF network element and the AF network element, and the communication interface may be an N5 interface.

The terminal device may be user equipment (UE), a handheld terminal, a notebook computer, a subscriber unit, a cellular phone, a smartphone, a wireless data card, a personal digital assistant (PDA) computer, a tablet computer, a wireless modem, a handheld (handheld) device, a laptop computer, a vehicle-mounted terminal, a cordless phone, a wireless local loop (WLL) station, a machine type communication (MTC) terminal, or another device that can access a network. The terminal device may include one or more USIMs.

The (R)AN device may include a RAN device and an AN device. The RAN device is a 3rd generation partnership project (3GPP) wireless network device, and the AN device is an access network device defined in a non-3GPP. The (R)AN device is a device that provides radio access for the terminal device, and is mainly responsible for functions such as radio resource management, QoS management, and data compression and encryption on an air interface side. The (R)AN device may include base stations in various forms, such as a macro base station, a micro base station (also referred to as a small cell), a relay station, and an access point. The (R)AN may further include a wireless fidelity (Wi-Fi) access point (AP). The (R)AN device may further include a worldwide interoperability for microwave access (WiMAX) base station (BS). The AN device allows interconnection and interworking between a terminal device and a 3GPP core network by using a non-3GPP technology. The non-3GPP technology may be wireless fidelity (Wi-Fi), WiMAX, a code division multiple access (CDMA) network, or the like. In systems using different radio access technologies, names of the (R)AN devices may be different. For example, a next-generation NodeB (gNB) is a 5G base station, an evolved NodeB (eNB) is a 4G base station, and a next-generation (ng)-eNB is a base station connecting 5G and 4G.

The UPF network element is responsible for forwarding and receiving user data in the terminal device. The UPF network element may receive the user data from the DN, and transmit the user data to the terminal device through the (R)AN device; or may receive the user data from the terminal device through the (R)AN device, and forward the user data to the DN. A transmission resource and a scheduling function on the UPF network element that serve the terminal device are managed and controlled by the SMF network element.

The DN is an operator network that provides a data transmission service for a user, for example, an internet protocol multimedia service (IMS) or the internet.

The AMF network element is a core network element, and is mainly responsible for signaling processing, for example, functions such as access control, mobility management, registration, deregistration, attachment and detachment, and gateway selection. When providing a service for a session of the terminal device, the AMF network element provides a control plane storage resource for the session, to store a session identifier, an SMF network element identifier associated with the session identifier, and the like.

The SMF network element is responsible for user plane network element selection, user plane network element redirection, internet protocol (IP) address assignment, bearer establishment, modification, and release, and QoS control.

The PCF network element mainly supports providing a unified policy framework to control network behavior, and providing a policy rule to a control layer network function, and is also responsible for obtaining policy-related subscription information of a subscriber.

The AF network element mainly supports interaction with a 3GPP core network to provide a service, for example, affecting a data routing decision, interacting with the PCF network element to perform measurement control, and providing some third-party services for a network side.

The UDM network element is responsible for user key management, user identifier processing, subscription data access authorization, network function entity management of UE, session and service continuity management, SMS message push, lawful interception, subscription management, and SMS message management, and is configured to manage and control user data, for example, manage subscription information.

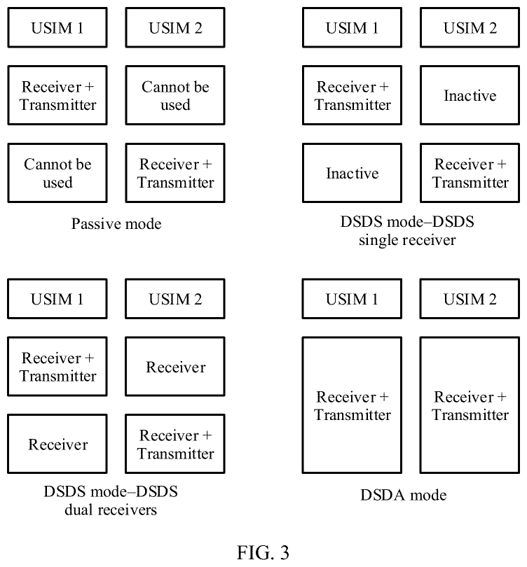

For better understanding the communication method and device disclosed in embodiments of the present invention, the following first describes an application scenario used in embodiments of the present invention. One terminal device may internally include one USIM, may include two USIMs, or may include more than two USIMs. The following uses two USIMs as an example for description. The two USIMs of the terminal device may be both oriented to a public network, or one of the two USIMs is used for a public network, and the other USIM is used for a private network or an enterprise network. The USIM may be a subscriber identity module (SIM) card or a USIM card. FIG. 3 is a schematic diagram of a terminal device with two USIMs according to an embodiment of the present invention.

As shown in FIG. 3, the terminal device with the two USIMs includes a passive mode, a dual SIM dual standby (DSDS) mode, and a dual SIM dual active (DSDA) mode.

Passive mode: The terminal device is provided with one receiver and one transmitter, and only one USIM can use the receiver and the transmitter at any moment.

DSDS mode: a DSDS single receiver and DSDS dual receivers are included. DSDS single receiver: The terminal device is provided with one receiver and one transmitter. When the two USIMs are in an idle state, the two USIMs can receive network side paging. When one USIM is in a connected state, the other USIM cannot receive network paging or send data. In other words, only one USIM is in a connected state, and the transmitter and the receiver can transmit service data for only one USIM. DSDS dual receivers: The terminal device is provided with two receivers and one transmitter. When the two USIMs are in an idle state, the two USIMs can receive network paging, and may respectively receive network paging on different receivers. When one USIM is in a connected state, the other USIM can receive network paging by using the other receiver. One transmitter can be used by only one USIM.

DSDA mode: The terminal device is provided with two receivers and two transmitters, and the two USIMs can work independently.

After the two USIMs are registered with a network, a USIM may be in a connected state or an idle state. Assuming that any USIM is in the connected state, there is a signaling connection between the terminal device and the network, and the terminal device may transmit service data. When the two USIMs are in the idle state, there is no signaling connection between the terminal device and the network, the terminal device cannot transmit service data, and the terminal device identifies and receives a network broadcast message and is periodically registered with the network.

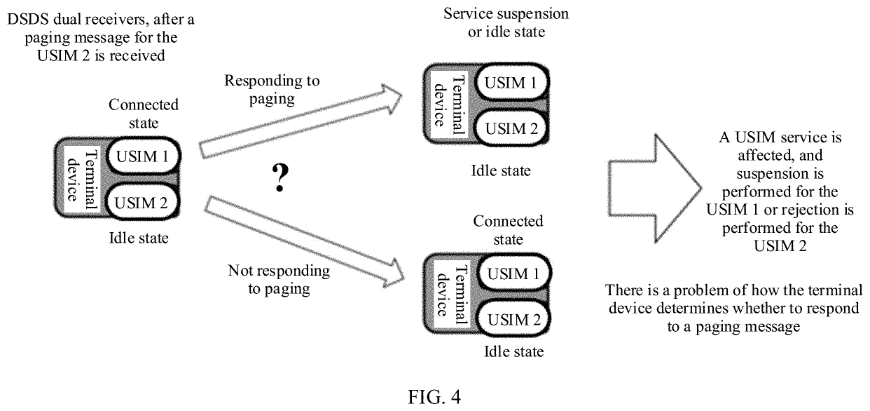

FIG. 4 is a schematic diagram of paging of DSDS dual receivers in a DSDS mode according to an embodiment of the present invention. As shown in FIG. 4, a terminal device is provided with two receivers and a single transmitter. When a USIM 1 is in a connected state, service data is transmitted between the USIM 1 and a network, and a USIM 2 is in an idle state, the network sends a paging message to the USIM 2 if the network needs to deliver service data to the USIM 2. After the USIM 2 receives the paging message, if the terminal device responds to the paging message, the service data of the USIM 1 is suspended, and the USIM 2 enters the connected state; or if the terminal device does not respond to the paging message, both the USIM 1 and the USIM 2 remain unchanged. A service of a USIM is affected regardless of whether the terminal device responds to the paging message or does not respond to the paging message.

In another application scenario, in the DSDS mode, a terminal device is provided with two receivers and a single transmitter, and one transmitter may be used by two USIMs in the connected state in a time division multiplexing manner. For example, when the USIM 1 is in the connected state and the USIM 2 is in the idle state, a time resource of the terminal device is exclusively used for service data transmission of the USIM 1, and the network sends a paging message to the USIM 2. After the USIM 2 receives the paging message, if the terminal device responds to the paging message, the USIM 2 enters the connected state, and service data of the USIM 1 and service data of the USIM 2 are sent to the network in the time division multiplexing manner. In this case, because the time resource used for service transmission of the USIM 1 is reduced, service data transmission performance of the USIM 1 is affected; or if the terminal device does not respond to the paging message, both the USIM 1 and the USIM 2 remain unchanged, and service data of the USIM 2 cannot be transmitted. Consequently, a service of a USIM is affected regardless of whether the terminal device responds to the paging message or does not respond to the paging message.

One USIM described in the background and the application scenario may correspond to one user. In the following embodiments, one USIM may correspond to one user, that is, a user may be in a one-to-one correspondence with a USIM, or one USIM may correspond to two or more users. This is not limited.

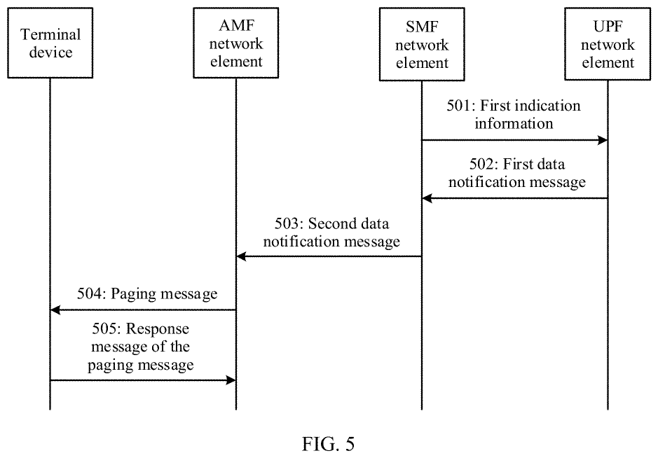

Based on the network architectures shown in FIG. 1 and FIG. 2, FIG. 5 is a schematic flowchart of a communication method according to an embodiment of the present invention. As shown in FIG. 5, the communication method may include the following steps.

501: An SMF network element sends first indication information to a UPF network element.

The first indication information may be used to indicate to include service information in a data notification message of a first USIM, or may be used to indicate to include service information in a data notification message when to-be-sent downlink data for a first USIM is data of a specific service. Optionally, the first indication information includes service detection rule information corresponding to the specific service. The service detection rule information may be used to indicate a service detection rule, and the information may include a data packet filter or a service data flow template. The data packet filter is a rule used to filter data. The specific service may be a video service of a merchant, a type of video service, or the like.

The first USIM is any one of at least two USIMs of a terminal device.

The terminal device has the at least two USIMs, that is, the at least two USIMs are provided on the terminal device, and the at least two USIMs are USIMs that have been registered with a network and can work normally, and may be subsequently referred to as the at least two USIMs of the terminal device.

Optionally, only one of the at least two USIMs of the terminal device can be in a connected state at a same moment. One transmitter may be disposed on the terminal device. At least two receivers may be further disposed on the terminal device. One receiver may be provided for each of the at least two USIMs, and a paging message of each USIM is received through a corresponding receiver. Alternatively, one receiver may be provided for two or more USIMs. In this case, a receiver may not be fixedly used by a USIM, and each of the at least two USIMs may use a same receiver, or some of the at least two USIMs may use a same receiver. When one USIM card slot corresponds to one USIM, at least two USIM card slots may be provided on the terminal device, and one USIM may be installed in each USIM card slot. When one USIM card slot corresponds to two or more USIMs, a small quantity of USIM card slots may be provided on the terminal device.

The service information may include a priority of a service, may include a service type of a service, or may include at least one of a 5QI, a DSCP, and a QFI of a service.

Service type information may be a service type identifier, or may be other information of a service type. This is not limited herein. The service type may be at a coarse granularity or a fine granularity. At the coarse granularity, the service type may be classified into data, a voice, a video, an SMS message, and the like. 2 bits are used as an example for description. When the service type identifier is 00, a service identified by the service type identifier is a data service. When the service type identifier is 01, a service identified by the service type identifier is a voice service. When the service type identifier is 10, a service identified by the service type identifier is a video service. At the fine granularity, voice services may be classified into an IMS-based telephone voice, a circuit switched (CS)-based telephone voice, a voice over the internet, and the like; video services may be classified into an IMS-based video, a video call over the internet, and an online video over the internet; SMS message services may be classified into an IMS-based SMS message, a CS-based SMS message, an internet-based SMS message; and data services may be web page browsing, map application, and the like. The IMS-based telephone voice may be a voice over new radio (VoNR), a voice over long term evolution (VoLTE), or the like. The CS-based telephone voice may be a voice over circuit switched fallback (CSFB) or the like. The voice over the internet may be an instant messaging voice service or the like. The IMS-based video may be a video over long term evolution (ViLTE) or the like. The video call over the internet may be an instant messaging application video or the like. The online video over the internet may be various videos on a browser.

502: The UPF network element sends a first data notification message to the SMF network element based on the first indication information.

For example, when the UPF network element has downlink data to be sent to the first USIM of the terminal device, that is, there is the to-be-sent downlink data for the first USIM, the UPF network element may send the first data notification message to the SMF network element based on the first indication information.

Specifically, assuming that the first indication information is indication information used to indicate to include the service information in the data notification message when the to-be-sent downlink data for the first USIM is the data of the specific service, if the to-be-sent downlink data for the first USIM of the terminal device is downlink data of the specific service, the UPF network element may send the first data notification message to the SMF network element, where the first data notification message may carry second service information of a first service corresponding to the to-be-sent downlink data; or if the to-be-sent downlink data for the first USIM of the terminal device is not downlink data of the specific service, the UPF network element may send, to the SMF network element, the first data notification message that does not carry second service information of a first service.

Specifically, assuming that the first indication information is used to indicate to include the service information in the data notification message of the first USIM, if there is the to-be-sent downlink data for the first USIM of the terminal device, the UPF network element may send the first data notification message to the SMF network element, where the first data notification message may carry the second service information of the first service corresponding to the to-be-sent downlink data.

The first data notification message is used to notify that there is the to-be-sent downlink data for the first USIM. The first data notification message may carry the second service information of the first service corresponding to the to-be-sent downlink data for the first USIM. The to-be-sent downlink data corresponds to the first service, that is, the to-be-sent downlink data is to-be-sent downlink data of the first service. The first service may be a video, audio, or the like.

The first data notification message may further carry a USIM identifier of the first USIM or an identifier that has an association relationship with the USIM identifier of the first USIM, and may indicate that there is the to-be-sent downlink data for the first USIM. USIM identifiers may be different in different communication systems. For example, in a 4G communication system, the USIM identifier may be an international mobile subscriber identity (IMSI), and in a 5G communication system, the USIM identifier may be a subscription permanent identifier (SUPI). The identifier that has the association relationship with the USIM identifier of the first USIM may be an N4 session identifier, and the SMF network element may obtain the USIM identifier through mapping based on the N4 session identifier. The association relationship with the USIM identifier of the first USIM may be a direct association relationship or an indirect association relationship with the USIM identifier of the first USIM. The association relationship may exist in a form of a table, or may exist in another form. The USIM identifier of the first USIM or the identifier that has the association relationship with the USIM identifier of the first USIM may identify that the first data notification message is a data notification message for the first USIM.

The second service information of the first service may include a priority of the first service, may include service type information of the first service, or may include at least one of a 5QI, a DSCP, and a QFI of the first service.

503: The SMF network element sends a second data notification message to an AMF network element based on the first data notification message.

The second data notification message may carry the second service information of the first service corresponding to the to-be-sent downlink data for the first USIM. The second data notification message may further carry the USIM identifier of the first USIM or the identifier that has the association relationship with the USIM identifier of the first USIM, and may indicate that there is the to-be-sent downlink data for the first USIM. The second data notification message may be an N1N2 message transfer (N1N2MessageTransfer) message sent by the SMF network element to the AMF network element.

504: The AMF network element sends a paging message to the terminal device based on the second data notification message.

The paging message may be a paging message corresponding to the first USIM, and may be used to page a user corresponding to the first USIM.

In addition, the paging message may carry first service information of the first service. The first service information of the first service and the second service information of the first service may be the same or may be different. The paging message may further carry the USIM identifier of the first USIM or the identifier that has the association relationship with the USIM identifier of the first USIM, and may indicate that the paging message is a paging message corresponding to the first USIM.

The first service information of the first service may include the priority of the first service, may include the service type information of the first service, or may include the at least one of the 5QI, the DSCP, and the QFI of the first service.

505: The terminal device sends a response message of the paging message to the AMF network element based on the first service information of the first service and service information of a second service.

Specifically, after receiving the paging message from the AMF network element, the terminal device may send the response message of the paging message to the AMF network element based on the first service information of the first service and the service information of the second service.

In an example, when the terminal device determines, based on the first service information of the first service and the service information of the second service, that the priority of the first service is higher than a priority of the second service, the terminal device may send the response message of the paging message to the AMF network element.

In another example, after the terminal device receives the paging message from the AMF network element, when each of the first service information of the first service and the service information of the second service includes the priority of the service, in step 505, the terminal device may determine, based on the priority of the first service and the priority of the second service, whether the priority of the first service is higher than the priority of the second service. When the priority of the first service is higher than the priority of the second service, the terminal device may send the response message of the paging message to the AMF network element. When the priority of the first service is not higher than the priority of the second service, the terminal device may not send the response message of the paging message to the AMF network element, in other words, may discard the paging message. When the first service information of the first service does not include the priority of the first service, and the service information of the second service includes the priority of the second service, in step 505, the terminal device may first obtain the priority of the first service based on the first service information of the first service, and then determine that the priority of the first service is higher than the priority of the second service.

In another example, when the first service information of the first service includes the at least one of the 5QI, the DSCP, and the QFI of the first service, that the terminal device obtains the priority of the first service based on the first service information of the first service in step 505 is specifically: The terminal device first obtains the service type information of the first service based on the first service information of the first service, and then obtains the priority of the first service based on the service type information of the first service.

Specifically, the priority of the first service may be obtained based on service priority information of the terminal device and the service type information of the first service. A correspondence between a 5QI value and a service type may be preconfigured in the terminal device. The correspondence may be that shown in Table 1.

TABLE 1
Correspondence between a 5QI value and a service type

| 5QI value | Default priority | Service type |
|---|---|---|
| 1 | 20 | Conversational voice |
| 2 | 40 | Conversational video (live streaming) |
| 3 | 30 | Real time gaming, vehicle-to-everything |
| | | (V2X) messages, electricity distribution- |
| | | medium voltage, and process automation |
| | | monitoring |
| 4 | 50 | Non-conversational video (buffered |
| | | streaming) |
| 65 | 7 | Mission-critical user plane push |
| | | to talk voice such as mission- |
| | | critical push to talk (MCPTT) |
| 66 | 20 | Non-mission-critical user plane |
| | | push to talk voice |
| 67 | 15 | Mission-critical video user plane |
| 75 | | |
| 71 | 56 | “Live” uplink streaming |
| 72 | 56 | “Live” uplink streaming |
| 73 | 56 | “Live” uplink streaming |
| 74 | 56 | “Live” uplink streaming |
| 76 | 56 | “Live” uplink streaming |
| 5 | 10 | IMS signaling |
| 6 | 60 | Video (buffered streaming) |
| 7 | 70 | Voice, video (live streaming), |
| | | and interactive gaming |
| 8 | 80 | Video (buffered streaming) and |
| 9 | 90 | transmission control protocol |
| | | (TCP)-based service |
| 69 | 5 | Mission-critical delay sensitive |
| | | signaling such as MCPTT signaling |
| 70 | 55 | Mission-critical data |
| 79 | 65 | V2X messages |
| 80 | 68 | Low latency enhanced mobile |
| | | broadband (eMBB) applications |
| | | augmented reality (AR) |
| 82 | 19 | Discrete automation |
| 83 | 22 | Discrete automation |
| 84 | 24 | Intelligent transport systems |
| 85 | 21 | Electricity distribution-high voltage |

As shown in Table 1, one 5QI value may correspond to one or more service types, and one 5QI value may correspond to one priority. The manner in Table 1 may be used for different terminal devices. The terminal device may also store a correspondence between a QFI value and a service type. In a PDU session establishment/modification process, the SMF network element may generate a QFI value for a new QoS flow, and then send a correspondence between a QFI value and a 5QI value to the terminal device. After receiving the correspondence between the QFI value and the 5QI value from the SMF network element, the terminal device may obtain a correspondence between a QFI value and a service type through mapping. Alternatively, when establishing a new QoS flow for a service in a session establishment/modification process, the terminal device may associate a QFI value corresponding to the new QoS flow with a requested service type, to obtain a correspondence between a QFI value and a service type. A correspondence between a DSCP value and a service type may be further preconfigured in the terminal device. The correspondence may be that shown in Table 2.

TABLE 2
Correspondence between a DSCP value and a service type

| DSCP value | Binary system | Description |
|---|---|---|
| 0 | 000 000 | CS0/best effort (BE) service |
| 8 | 001 000 | CS1: middle priority |
| 10 | 001 010 | Amplify-and-forward (AF) 11/AF1 |
| | | low dropout (low drop, LP) |
| 12 | 001 100 | AF12/AF1 middle dropout (middle |
| | | drop, MP) |
| 14 | 001 110 | AF13/AF1 high dropout (high drop, HP) |
| 16 | 010 100 | CS2: high priority |
| 18 | 010 010 | AF21/AF2LP |
| 20 | 010 100 | AF22/AF2MP |
| 22 | 010 110 | AF23/AF2HP |
| 24 | 011 000 | CS3: call signal |
| 26 | 011 010 | AF31/AF3LP |
| 28 | 011 100 | AF32/AF3MP |
| 30 | 011 110 | AF33/AF3HP |
| 32 | 100 000 | CS4: video conference |
| 34 | 100 010 | AF41/AF4LP |
| 36 | 100 100 | AF42/AF4MP |
| 38 | 100 110 | AF43/AF4HP |
| 40 | 101 000 | CS5: voice |
| 46 | 101 110 | An entity framework (EF) corresponds |
| | | to real-time services that require a |
| | | low latency, low jitter, and a low packet |
| | | loss rate, such as a video, a voice, and |
| | | video conferencing in actual applications |
| 48 | 110 000 | CS6 |
| 56 | 111 000 | CS7 |

In another example, when the first service information of the first service includes the at least one of the 5QI, the DSCP, and the QFI of the first service, and the service information of the second service includes service type information of the second service, that the terminal device determines, based on the first service information of the first service and the service information of the second service, that the priority of the first service is higher than a priority of the second service may be specifically: The terminal device first determines at least one of a 5QI value, a DSCP value, and a QFI value of the second service based on the service type information of the second service, and then determines a priority sequence of the first service and the second service based on the at least one of the 5QI value, the DSCP value, and the QFI value of the first service and the at least one of the 5QI value, the DSCP value, and the QFI value of the second service.

Specifically, the priority of the first service may be first determined based on the at least one of the 5QI value, the DSCP value, and the QFI value of the first service, the priority of the second service may be determined based on the at least one of the 5QI value, the DSCP value, and the QFI value of the second service, and then the priority sequence of the first service and the second service is determined based on the priority of the first service and the priority of the second service.

In the communication method described in FIG. 5, the SMF network element may send the indication information to the UPF network element, so that the first data notification message sent by the UPF network element to the SMF network element carries the service information of the service. The second data notification message sent by the SMF network element to the AMF network element carries the service information of the service, so that the AMF network element can include the service information of the service in the paging message based on the service information, of the service, carried in the second data notification message. Therefore, the terminal device may determine, based on the service information, of the service, carried in the paging message and service information of a service of the USIM currently in the connected state on the terminal device, whether to respond to the paging message instead of blindly responding to the paging message, to avoid suspending the service of the USIM currently in the connected state on the terminal device once the paging message is received.

It should be noted that when the first data notification message fixedly carries the service information of the service, in other words, all data notification messages sent by the UPF network element carry the service information, the SMF network element may not perform the step of sending the first indication information to the UPF network element, in other words, step 501 is not performed. Step 502 may be replaced with the following step: The UPF network element sends the first data notification message to the SMF network element. The second data notification message in step 503 also carries the service information of the service. In step 504, the AMF network element may send, to the terminal device based on the indication information, the paging message that carries the service information of the service. The indication information may be indication information, from the terminal device, used to indicate to include the service information of the service in the paging message sent to the terminal device, or may be USIM capability information that is of the terminal device and that is used to indicate that the terminal device supports the at least two USIMs, or may be the service priority information of the terminal device, or may be the service information of the second service from the terminal device, or may be indication information from the SMF network element or a UDM network element, or may be a combination of at least two of the foregoing information. For example, the first data notification message carries a QFI, and the second data notification message may carry only a QFI, or may carry only a 5QI, or may carry the QFI and a 5QI. The 5QI may be determined based on a correspondence between the 5QI and the QFI. For another example, the first data notification message carries a QFI and a DSCP, and the second data notification message may carry a QFI, or may carry a DSCP, or may carry a QFI and a DSCP, may include a DSCP and a 5QI, or may include a 5QI, a QFI, and a DSCP. For another example, the first data notification message carries a DSCP, and the second data notification message carries a DSCP.

Optionally, the method further includes: The terminal device may send, to the AMF network element, the indication information used to indicate to include the service information of the service in the paging message sent to the terminal device, and the AMF network element receives, from the terminal device, the indication information used to indicate to include the service information of the service in the paging message sent to the terminal device. In step 504, the AMF network element may send the paging message to the terminal device based on the second data notification message and the indication information, that is, send, to the terminal device based on the indication information, the paging message carrying the first service information of the first service. The AMF network element may include the service information of the service in the paging message based on the indication information sent by the terminal device, so that the terminal device may determine, based on the service information, of the service, carried in the paging message, whether to respond to the paging message.

Optionally, in an implementation scenario of the foregoing embodiment, the method further includes: The terminal device sends, to the AMF network element, the indication information used to indicate to include the service information of the service in the paging message sent to the terminal device. Correspondingly, the AMF network element receives, from the terminal device, the indication information used to indicate to include the service information of the service in the paging message sent to the terminal device, and sends the indication information to the SMF network element. The SMF network element receives the indication information from the AMF network element. In step 501, the SMF network element may send the first indication information to the UPF network element based on the indication information. In step 504, the AMF network element may send the paging message to the terminal device based on the second data notification message and the indication information. The SMF network element may send the first indication information to the UPF network element based on the indication information sent by the terminal device, so that the first data notification message sent by the UPF network element to the SMF network element based on the first indication information carries the service information of the service, and the second data notification message sent by the SMF network element to the AMF network element carries the service information of the service. Therefore, the AMF network element may include the service information of the service in the paging message based on the second data notification message and the indication information, and then the terminal device may determine, based on the service information, of the service, carried in the paging message, whether to respond to the paging message.

Optionally, in an implementation scenario of the foregoing embodiment, the method further includes: The SMF network element may receive the first indication information from a PCF network element.

The first indication information may be obtained by the SMF network element from the PCF network element in the session establishment or session modification process. The first indication information may be obtained by the PCF network element from a unified data repository (UDR) network element, or may be generated by the PCF network element. When the first indication information is obtained by the PCF network element from the UDR network element, the method may further include: The PCF network element obtains the first indication information from the UDR network element. Specifically, the PCF network element may obtain subscription data information of the first USIM from the UDR network element, where the subscription data information of the first USIM includes the first indication information.

Optionally, in an implementation scenario of the foregoing embodiment, the method further includes: The SMF network element receives the first indication information from the UDM network element.

The first indication information may be obtained by the SMF network element from the UDM network element in a session establishment or session modification process. Specifically, the first indication information may be obtained by the UDM network element from a UDR network element, or may be generated by the UDM network element.

When the first indication information is obtained by the UDM network element from the UDR network element, the method may further include: The UDM network element obtains the first indication information from the UDR network element. Specifically, the UDM network element may obtain subscription data information of the first USIM from the UDR network element, where the subscription data information of the first USIM includes the first indication information.

Optionally, the first indication information may be generated by the SMF network element.

Optionally, in an implementation scenario of the foregoing embodiment, the method further includes: The terminal device sends, to the AMF network element, the USIM capability information that is of the terminal device and that is used to indicate that the terminal device supports the at least two USIMs, and the AMF network element receives the USIM capability information of the terminal device.

Further, in step 504, the AMF network element may send the paging message to the terminal device based on the second data notification message and the USIM capability information of the terminal device.

For example, after the AMF network element receives the second data notification message and the USIM capability information of the terminal device from the SMF network element, in step 504, the AMF network element may send the paging message to the terminal device based on the second data notification message and the USIM capability information of the terminal device. Specifically, the AMF network element may first determine whether one of the at least two USIMs supported by the terminal device is in the connected state, and send the paging message to the terminal device when one of the at least two USIMs supported by the terminal device is in the connected state. When the at least two USIMs supported by the terminal device each are in an idle state, the AMF network element may send, to the terminal device, the paging message that does not carry the first service information of the first service. The USIM capability information of the terminal device may be sent in a registration procedure of the terminal device.

The terminal device may send, to the AMF network element, the USIM capability information that is of the terminal device and that is used to indicate that the terminal device supports the at least two USIMs, so that the AMF network element may include the service information of the service in the paging message based on the USIM capability information of the terminal device.

Optionally, in an implementation scenario of the foregoing embodiment, the method further includes: The terminal device sends, to the AMF network element, the USIM capability information that is of the terminal device and that is used to indicate that the terminal device supports the at least two USIMs, the AMF network element receives the USIM capability information of the terminal device and sends the USIM capability information of the terminal device to the SMF network element, and the SMF network element receives the USIM capability information from the terminal device.

Further, in step 501, the SMF network element may send the first indication information to the UPF network element based on the USIM capability information of the terminal device.

Specifically, after receiving the USIM capability information of the terminal device, the SMF network element may send the first indication information to the UPF network element. To be specific, the USIM capability information is used as a trigger condition for sending the first indication information by the SMF network element. Alternatively, after receiving the USIM capability information of the terminal device, the SMF network element may first determine whether there is a USIM in the connected state in the at least two USIMs supported by the terminal device. When there is the USIM in the connected state in the at least two USIMs supported by the terminal device, the SMF network element sends the first indication information to the UPF network element.

The SMF network element may send the indication information to the UPF network element based on the USIM capability information of the terminal device, so that the first data notification message sent by the UPF network element to the SMF network element carries the service information of the service, and the second data notification message sent by the SMF network element to the AMF network element carries the service information of the service. Therefore, the AMF network element may include the service information of the service in the paging message based on the second data notification message and the USIM capability information of the terminal device, and then the terminal device may determine, based on the service information, of the service, carried in the paging message, whether to respond to the paging message.

It should be noted that the SMF network element may obtain USIM status information from the AMF network element. The USIM status information may be the connected state or the idle state.

The USIM capability information of the terminal device may carry or include an identifier of each of the at least two USIMs of the terminal device.

The first indication information may be obtained by the SMF network element from the PCF network element or the UDM network element after the SMF network element receives the USIM capability information of the terminal device, or may be generated by the SMF network element after the SMF network element receives the USIM capability information of the terminal device, or may be obtained by the SMF network element from the PCF network element or the UDM network element in advance.

Optionally, in an implementation scenario of the foregoing embodiment, the method further includes: The terminal device sends, to the AMF network element, the USIM capability information that is of the terminal device and that is used to indicate that the terminal device supports the at least two USIMs, the AMF network element receives the USIM capability information of the terminal device and sends the USIM capability information of the terminal device to the SMF network element, the SMF network element receives the USIM capability information of the terminal device and sends the USIM capability information of the terminal device to the UPF network element, and the UPF network element receives the USIM capability information of the terminal device.

When the UPF network element has downlink data to be sent to the first USIM of the terminal device, and the USIM capability information of the terminal device carries or includes the identifier of each of the at least two USIMs of the terminal device, step 502 may be replaced with the following step: The UPF network element sends the first data notification message to the SMF network element based on the USIM capability information of the terminal device.

Specifically, the UPF network element may query whether one of the at least two USIMs has context information, and when one of the at least two USIMs has the context information and the USIM is not the first USIM, send the first data notification message to the SMF network element. When one of the at least two USIMs has the context information and the USIM is the first USIM, the UPF network element may send the to-be-sent downlink data for the first USIM to the first USIM of the terminal device through a RAN device.

It should be noted that the USIM capability information of the terminal device may be used to indicate that the terminal device supports the at least two USIMs, used to indicate a quantity of receivers or a quantity of transmitters of the terminal device, or used to indicate that the terminal device supports time division multiplexing of a transmitter. In addition, the USIM capability information of the terminal device may further include any combination of the foregoing several types of indication information.

The UPF network element may include, based on the USIM capability information of the terminal device, the service information of the service in the first data notification message sent to the SMF network element, and the second data notification message sent by the SMF network element to the AMF network element carries the service information of the service, so that the AMF network element may include the service information of the service in the paging message based on the second data notification message and the USIM capability information of the terminal device, and then the terminal device may determine, based on the service information, of the service, carried in the paging message, whether to respond to the paging message.

Optionally, in an implementation scenario of the foregoing embodiment, when the second service information of the first service does not include the priority of the first service, and the first service information of the first service includes the priority of the first service, the method further includes: The terminal device sends the service priority information of the terminal device to the AMF network element, the AMF network element receives the service priority information of the terminal device, and the AMF network element determines the first service information of the first service based on the service priority information of the terminal device and the second service information of the first service. The AMF network element may determine, based on the service priority information of the terminal device, whether to include the service information of the service in the paging message.

For different terminal devices, priorities corresponding to a same service may be the same or may be different.

The service priority information of the terminal device is used to indicate a priority of the service. The service priority information of the terminal device may be that shown in Table 3.

TABLE 3
Service priority information of a terminal device

| Identifier of a service | Priority level |
|---|---|
| Service 1 | 2 |
| Service 2 | 4 |
| . . . | . . . |

As shown in Table 3, each service corresponds to one priority level. A higher priority level may indicate a higher priority, or a lower priority level may indicate a lower priority. The identifier of the service may be service type information of the service, or may be a 5QI value of the service, a DSCP value of the service, or a QFI value of the service. The service priority information of the terminal device may alternatively be that shown in Table 4.

TABLE 4
Service priority information of a terminal device
5QI value
5
4
. . .

As shown in Table 4, 5QI values may be sorted in descending order of priorities, or may be sorted in ascending order of priorities. Alternatively, the 5QI value in Table 4 may be replaced with a DSCP value, a QFI value, a 5QI value and a DSCP value, a 5QI value and a QFI value, a DSCP value and a QFI value, or a 5QI value, a DSCP value, and a QFI value. When the 5QI value in Table 4 is replaced with two or three of the 5QI value, the DSCP value, and the QFI value, a priority ranking may be determined based on an accumulated sum of the 5QI value, the DSCP value, and the QFI value, or may be determined based on a weighted sum of the 5QI value, the DSCP value, and the QFI value. The service priority information of the terminal device may alternatively be that shown in Table 5.

TABLE 5
Service priority information of a terminal device
Identifier of a service

Service 1
Service 3
Service 5
. . .

As shown in Table 5, identifiers of services may be sorted in descending order of priorities of the services, or may be sorted in ascending order of priorities of the services. The service priority information of the terminal device may be customized, or may be configured. For example, a priority of the voice service is higher than a priority of the video service. When the service priority information of the terminal device does not include the QFI value, because the service type information, the DSCP value, and the 5QI value are fixed, the terminal device may report the service priority information of the terminal device to the AMF network element in a registration procedure. When the service priority information of the terminal device includes the QFI value, because the QFI value is dynamically generated, the terminal device needs to report the service priority information of the terminal device to the AMF network element each time the QFI value is updated. The service priority information of the terminal device may alternatively be that shown in Table 6.

TABLE 6
Service priority information of a terminal device

| 5QI value of a service | Priority level |
|---|---|
| 1 | 20 |
| 2 | 40 |
| . . . | . . . |

As shown in Table 6, a 5QI value of each service corresponds to one priority level. A higher priority level may indicate a higher priority, or a lower priority level may indicate a lower priority. Alternatively, the 5QI value in Table 6 may be replaced with a DSCP value, a QFI value, a 5QI value and a DSCP value, a 5QI value and a QFI value, a DSCP value and a QFI value, or a 5QI value, a DSCP value, and a QFI value. When the 5QI value in Table 6 is replaced with two or three of the 5QI value, the DSCP value, and the QFI value, a priority ranking may be determined based on an accumulated sum of the 5QI value, the DSCP value, and the QFI value, or may be determined based on a weighted sum of the 5QI value, the DSCP value, and the QFI value.

Optionally, in an implementation scenario of the foregoing embodiment, when the second service information of the first service includes the priority of the first service, the method further includes: The terminal device sends the service priority information of the terminal device to the AMF network element, the AMF network element receives the service priority information of the terminal device and sends the service priority information of the terminal device to the SMF network element, the UPF network element receives the service priority information of the terminal device and determines the second service information of the first service based on the service priority information of the terminal device. The terminal device may send the service priority information of the terminal device to the UPF network element, so that a data notification message sent by the UPF network element may carry the priority of the service.

Specifically, the UPF network element may determine, based on the to-be-sent downlink data for the first USIM and the service priority information of the terminal device, the priority of the first service corresponding to the to-be-sent downlink data.

Optionally, in an implementation scenario of the foregoing embodiment, when the second service information of the first service includes the service type information of the first service, and the service type information of the first service is a service type identifier of the first service, the method further includes: The UPF network element may determine the service type identifier of the first service.

Specifically, the UPF network element may determine the service type identifier of the first service based on a service detection rule. The service detection rule may be obtained by the UPF network element from a network management system, the SMF network element, or a network data analysis function (NWDAF) network element. The NWDAF network element may construct a service identification model library based on a service feature database by using a machine learning technology. The model library includes a mapping relationship between a data packet detection feature and a service type.

The service detection rule may be a mapping relationship between a port number and a service type. For example, a port 80 indicates an internet access application. Alternatively, the service detection rule may be a mapping relationship between a source internet protocol address (IP address)+a port number and a service type, for example, a server IP address corresponding to a video and a port used for a video service. Alternatively, the service detection rule may be a mapping relationship between an application protocol identification model or a data packet content detection model and a service type. For example, a UPF network element side may implement application layer protocol identification or data packet content detection based on a deep packet inspection (DPI) technology. A correspondence between a service type identifier and a service type (data, a voice, a video, or the like) may be preconfigured in the terminal device and the UPF network element. The terminal device may obtain the correspondence by using a terminal device policy message provided by the PCF network element in the registration procedure. The correspondence may alternatively be included in the service detection rule, or may be obtained from the network management system.

Optionally, in an implementation scenario of the foregoing embodiment, when the second service information of the first service includes the at least one of the 5QI, the DSCP, and the QFI of the first service, the method further includes: The UPF network element obtains the DSCP value from a data packet header. The DSCP is a QoS classification standard defined by the internet engineering task force (IETF) and exists in an IP header part of a data packet. The UPF network element may obtain, through mapping, the QFI value and the 5QI value from a received data flow according to an existing packet detection rule. The packet detection rule may be configured when a protocol data unit (PDU) session is established or modified. The QFI is used to identify a unique QoS flow of a PDU session in a 5G system. One PDU session may have a plurality of QoS flows. The DSCP is used by the SMF network element to determine a paging policy indicator (PPI), and the 5QI is used by the AMF network element to determine a paging priority.

Optionally, in an implementation scenario of the foregoing embodiment, when the first data notification message does not carry the priority of the first service, and the second data notification message carries the priority of the first service, the method further includes: The terminal device sends the service priority information of the terminal device to the AMF network element. Correspondingly, the AMF network element receives the service priority information of the terminal device and sends the service priority information of the terminal device to the SMF network element. The SMF network element receives the service priority information of the terminal device and determines the priority of the first service based on the service information, of the first service, carried in the first data notification message and the service priority information of the terminal device.

Optionally, in an implementation scenario of the foregoing embodiment, when the first service information of the first service is different from the second service information of the first service, the method further includes: The AMF network element obtains the first service information of the first service based on the second service information of the first service.

Optionally, in an implementation scenario of the foregoing embodiment, the method further includes: The terminal device sends the service information of the second service to the AMF network element. Correspondingly, the AMF network element receives the service information of the second service from the terminal device, and in step 504, the AMF network element sends the paging message to the terminal device based on the second data notification message, the second service information of the first service, and the service information of the second service. The AMF network element may determine, based on the service information, of the service of the USIM currently in the connected state, reported by the terminal device, whether to send the paging message and whether to include the service information of the service in the paging message.

Specifically, when the AMF network element determines, based on the second service information of the first service and the service information of the second service, that the priority of the first service is higher than the priority of the second service, the AMF network element may send the paging message to the terminal device. When the AMF network element determines, based on the second service information of the first service and the service information of the second service, that the priority of the first service is not higher than the priority of the second service, the AMF network element may not send the paging message to the terminal device.

More specifically, the AMF network element may determine, based on the service priority information of the terminal device, the second service information of the first service, and the service information of the second service, that the priority of the first service is higher than the priority of the second service. In this case, the method may further include: The terminal device sends the service priority information of the terminal device to the AMF network element, the AMF network element receives the service priority information of the terminal device and determines a ranking of the priority of the first service and the priority of the second service based on the service priority information of the terminal device, the second data notification message, and the service information of the second service.

The second service is a current service of a second USIM in the at least two USIMs of the terminal device, and the second USIM is in a connected state. The current service of the second USIM may include one or more services. This is not limited.

Specifically, when the terminal device has a USIM in the connected state, the terminal device may send the service information of the second service on the USIM, in the connected state, of the terminal device to the AMF network element. For example, when the second USIM just enters the connected state, the terminal device may send the service information of the second service to the AMF network element, and may send the service information of the second service to the AMF network element again after the service subsequently changes.

When the current service of the second USIM includes at least two services, the second service may be a service with a highest priority in the at least two services.

The service information of the second service may include the priority of the second service, may include the service type information of the second service, or may include the at least one of the 5QI, the DSCP, and the QFI of the second service.

Optionally, in an implementation scenario of the foregoing embodiment, the method further includes: The AMF network element obtains subscription information of the terminal device from the UDM network element. In step 504, the AMF network element sends the paging message to the terminal device based on the second data notification message and the subscription information of the terminal device.

Specifically, the AMF network element may determine, based on the subscription information of the terminal device, whether to include the first service information of the first service in the paging message. The AMF network element may first determine whether the subscription information of the terminal device includes a subscription paging indication. When the subscription information of the terminal device includes the paging indication, the paging message carries the first service information of the first service. When the subscription information of the terminal device does not include the paging indication, the paging message does not carry the first service information of the first service. The paging indication may be a service subscribed to by the terminal device.

Optionally, in an implementation scenario of the foregoing embodiment, in step 504, the AMF network element may send the paging message to the terminal device based on the second data notification message through the RAN device.

Specifically, the AMF network element sends a first paging message to the RAN device based on the second data notification message. The first paging message may carry the service information of the first service and indication information used to indicate the RAN device to include the first service information of the first service in the paging message. After receiving the first paging message from the AMF network element, the RAN device may send, to the terminal device based on the indication information, a second paging message carrying the first service information of the first service.

Optionally, after the AMF network element receives the second data notification message from the SMF network element, the method further includes: Step 504 is performed when there is the USIM in the connected state on the terminal device, in other words, when the terminal device has the USIM in the connected state. The AMF network element may send, to the terminal device based on the second data notification message, the paging message that does not carry the first service information of the first service when there is no USIM in the connected state on the terminal device, in other words, the terminal device has no USIM in the connected state, or the at least two USIMs of the terminal device are in the idle state.

Alternatively, the AMF network element may combine the foregoing two or more types for use. For example, after receiving the indication information from the terminal device and/or the USIM capability information of the terminal device, the AMF network element determines, based on the second service information of the first service, whether to send the paging message to the terminal device.

Optionally, in an implementation scenario of the foregoing embodiment, after the terminal device receives the paging message from the AMF network element, the method further includes: Step 505 is performed when the terminal device has the USIM in the connected state. The terminal device may send the response message of the paging message to the AMF network element when the terminal device has no USIM in the connected state, in other words, the at least two USIMs of the terminal device are in the idle state.

Optionally, in an implementation scenario of the foregoing embodiment, after the terminal device receives the paging message from the AMF network element, the method further includes: The terminal device determines, based on the first service information of the first service and the service information of the second service, whether a QoS flow of the second service is affected after the first service and the second service are simultaneously transmitted, and performs step 505 if the QoS flow of the second service is not affected, or does not send the response message of the paging message to the AMF network element if the QoS flow of the second service is affected. Specifically, the terminal device may determine a wireless transmission resource requirement of the first service based on the first service information of the first service, determine a QoS requirement of the second service based on the second service information, and then determine, based on the wireless transmission resource requirement of the first service, whether the QoS flow of the second service is affected.

Optionally, the response message of the paging message may be a service request message sent by the terminal device to the AMF network element.

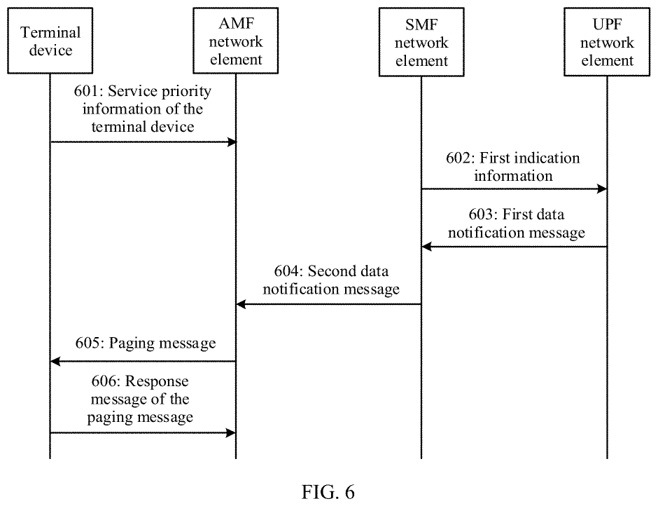

Based on the network architectures shown in FIG. 1 and FIG. 2, FIG. 6 is a schematic flowchart of another communication method according to an embodiment of the present invention. As shown in FIG. 6, the communication method may include the following steps.

601: A terminal device sends service priority information of the terminal device to an AMF network element.

The terminal device may send the service priority information of the terminal device to the AMF network element. When at least two USIMs of the terminal device are registered with different AMF network elements, the service priority information of the terminal device may be sent to each of these AMF network elements. For detailed descriptions of the service priority information of the terminal device, refer to the foregoing descriptions.

AMF network elements with which all of the at least two USIMs of the terminal device are registered may be the same or may be different.

For other detailed descriptions, refer to the foregoing corresponding descriptions.

602: An SMF network element sends first indication information to a UPF network element.

For detailed descriptions, refer to the foregoing corresponding descriptions. Details are not described herein again.

603: The UPF network element sends a first data notification message to the SMF network element based on the first indication information.

For detailed descriptions, refer to the foregoing corresponding descriptions. Details are not described herein again.

604: The SMF network element sends a second data notification message to the AMF network element based on the first data notification message.

For detailed descriptions, refer to the foregoing corresponding descriptions. Details are not described herein again.

605: The AMF network element sends a paging message to the terminal device based on the service priority information of the terminal device and the second data notification message.

After receiving the service priority information of the terminal device from the terminal device and the second data notification message from the SMF network element, the AMF network element may send the paging message to the terminal device based on the service priority information of the terminal device and the second data notification message. Specifically, the paging message may be sent to the terminal device based on the service priority information of the terminal device and second service information of a first service. More specifically, the AMF network element may send the paging message to the terminal device based on the service priority information of the terminal device, the second service information of the first service, and service information of a second service. For detailed descriptions, refer to the foregoing corresponding descriptions.

606: The terminal device sends a response message of the paging message to the AMF network element.

In the communication method described in FIG. 6, the terminal device may send, to the AMF network element, the service priority information that is of the terminal device and that is used to indicate a priority of a service, so that the AMF network element may determine, based on the service priority information of the service, whether to include service information of the service in the paging message.

Optionally, the method further includes: The terminal device may send the service information of the second service to the AMF network element. For detailed descriptions, refer to the foregoing descriptions.

Optionally, the method further includes: The terminal device sends, to the AMF network element, a paging-restricted indication used to indicate not to send the paging message to a first USIM.

The paging-restricted indication may carry an identifier of the first USIM.

For example, when the second service has a highest priority in services supported by the terminal device, the terminal device may send the paging-restricted indication to the AMF network element. Specifically, the terminal device may send the paging-restricted indication to the AMF network element when a processed service is a service with a highest priority in services supported by the terminal device, or may send the paging-restricted indication to the AMF network element when receiving an instruction that is entered by a user and that is used to send the paging-restricted indication. The method further includes: When the second service ends, the terminal device may send a paging-restricted cancellation indication to the AMF network element, where the paging-restricted cancellation indication is used to indicate to cancel the paging-restricted indication. The paging-restricted indication may be a message, or may be information in the message. The paging-restricted indication and the service information of the second service may be sent periodically or through event triggering to an AMF network element with which the first USIM is registered. A trigger event may be a service change. When the first USIM and a second USIM are registered with a same AMF network element, the terminal device may not send the service information of the second service to the AMF network element.

In this embodiment of this application, after the terminal device receives the paging message sent by the AMF network element based on the service priority information of the terminal device, because the paging message is sent by the AMF network element to the terminal device based on the service priority information of the terminal device, the terminal device may directly send the response message of the paging message to the AMF network element. When the paging message carries first service information of the first service, the terminal device may alternatively send the response message of the paging message to the AMF network element based on the first service information of the first service and the service information of the second service. For detailed descriptions, refer to the foregoing corresponding descriptions.

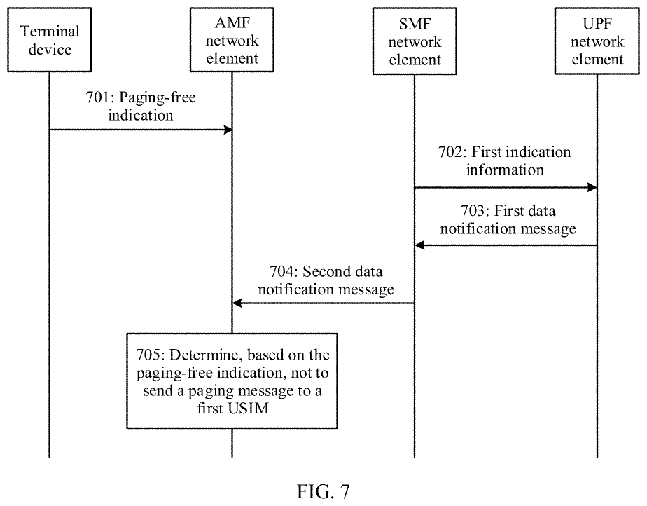

Based on the network architectures shown in FIG. 1 and FIG. 2, FIG. 7 is a schematic flowchart of still another communication method according to an embodiment of the present invention. As shown in FIG. 7, the communication method may include the following steps.

701: A terminal device sends a paging-restricted indication to an AMF network element.

The paging-restricted indication may indicate not to send a paging message to a first USIM, and the first USIM is any USIM in an idle state in at least two USIMs of the terminal device. The paging-restricted indication may carry an identifier of the first USIM, so that a specific USIM to which the paging message is not sent may be determined based on the identifier.

Optionally, in step 701, when a second service has a highest priority in services supported by the terminal device, the terminal device sends the paging-restricted indication to the AMF network element, where the second service is a current service of a second USIM in the at least two USIMs of the terminal device, and the second USIM is in a connected state.

Optionally, the method further includes: When the second service ends, the terminal device may send a paging-restricted cancellation indication to the AMF network element, where the paging-restricted cancellation indication may indicate to cancel the paging-restricted indication.

702: An SMF network element sends first indication information to a UPF network element.

For detailed descriptions, refer to the foregoing corresponding descriptions. Details are not described herein again.

703: The UPF network element sends a first data notification message to the SMF network element based on the first indication information.

For detailed descriptions, refer to the foregoing corresponding descriptions. Details are not described herein again.

704: The SMF network element sends a second data notification message to the AMF network element based on the first data notification message.

For detailed descriptions, refer to the foregoing corresponding descriptions. Details are not described herein again.

705: The AMF network element determines, based on the paging-restricted indication, not to send the paging message to the first USIM.

After receiving the paging-restricted indication from the terminal device and the second data notification message from the SMF network element, the AMF network element may determine, based on the paging-restricted indication, not to send the paging message to the first USIM.

After receiving the paging-restricted cancellation indication from the terminal device, when receiving another second data notification message from the SMF network element for the first USIM, the AMF network element may send the paging message to the terminal device.

In the communication method described in FIG. 7, the terminal device may send, to the AMF network element, the paging-restricted indication used to indicate not to send the paging message to the first USIM, so that the AMF network element may not send the paging message to the first USIM of the terminal device based on the paging-restricted indication, and a quantity of messages may be reduced. Therefore, transmission resources can be saved. The first USIM is any USIM in an idle state in the at least two USIMs of the terminal device.

Based on the embodiment shown in FIG. 7, this application further provides another embodiment. In this embodiment, a first data notification message sent in step 703 fixedly carries service information of a service, and an SMF network element does not need to send first indication information to a UPF network element. Therefore, step 702 does not need to be performed. Step 703 is replaced with the following step: The UPF network element sends the first data notification message to the SMF network element. A second data notification message in step 704 also carries service information of a service. The service information may be a 5QI.

Based on the embodiment shown in FIG. 7, this application further provides another embodiment. In this embodiment, an AMF network element sends, to an SMF network element, a paging-restricted indication received from a terminal device, and the SMF network element determines, based on the paging-restricted indication, not to send a second data notification message to the AMF network element. The second data notification message is a data notification message corresponding to a first USIM.

Based on the network architectures shown in FIG. 1 and FIG. 2, FIG. 8 is a schematic flowchart of still another communication method according to an embodiment of the present invention. As shown in FIG. 8, the communication method may include the following steps.

801: A UPF network element receives downlink data.

802: The UPF network element determines service type information of a first service corresponding to the downlink data.

After receiving the downlink data from a DN, the UPF network element may determine the service type information of the first service corresponding to the downlink data. The UPF network element may determine a service type identifier of the first service based on a service detection rule and the downlink data. For detailed descriptions, refer to the foregoing corresponding descriptions.

803: The UPF network element sends, to an SMF network element, a first data notification message that carries the service type information of the first service.

After determining the service type information of the first service corresponding to the downlink data, the UPF network element may send, to the SMF network element, the first data notification message that carries the service type information of the first service. Specifically, the UPF network element may send, to the SMF network element based on first indication information, the first data notification message that carries the service type information of the first service. For detailed descriptions, refer to the foregoing corresponding descriptions.

804: The SMF network element sends, to an AMF network element, a second data notification message that carries the service type information of the first service.

After receiving the first data notification message from the UPF network element, the SMF network element may send, to the AMF network element, the second data notification message that carries the service type information of the first service. For detailed descriptions, refer to the foregoing corresponding descriptions.

805: The AMF network element sends, to a RAN device, a paging message that carries the service type information of the first service.

After receiving the second data notification message from the SMF network element, the AMF network element may send, to the RAN device, the paging message that carries the service type information of the first service. For detailed descriptions, refer to the foregoing corresponding descriptions.

Optionally, the AMF network element may indicate, in the paging message, the RAN device to include the service type information of the first service in the paging message. For example, the paging message may carry indication information used to indicate to include the service type information of the first service in the paging message.

806: The RAN device sends, to a terminal device, a paging message that carries the service type information of the first service.

After receiving the paging message from the AMF network element, the RAN device may send, to the terminal device, the paging message that carries the service type information of the first service. The RAN device may directly forward, to the terminal device, the paging message received from the AMF network element. Alternatively, the RAN device may include the service type information of the first service in the paging message based on the indication information of the AMF network element.

807: The terminal device compares the first service with a second service.

After receiving the paging message from the RAN device, the terminal device may compare the first service with the second service. Specifically, the terminal device may obtain the service type information of the first service from the paging message, obtain service type information of the second service of a USIM currently in a connected state, and then compare the service type information of the first service with the service type information of the second service.

For detailed descriptions, refer to the foregoing corresponding descriptions.

808: The terminal device sends a service request to the AMF network element through the RAN device.

After comparing the first service with the second service, when determining to respond to the paging message, the terminal device may send the service request to the AMF network element through the RAN device, to establish a connection, so that a first USIM is in the connected state.

In the communication method described in FIG. 8, the terminal device may determine, based on service information, of a service, carried in the paging message and service information of a service of the USIM currently in the connected state on the terminal device, whether to respond to the paging message instead of blindly responding to the paging message, to avoid suspending the service of the USIM currently in the connected state on the terminal device once the paging message is received.

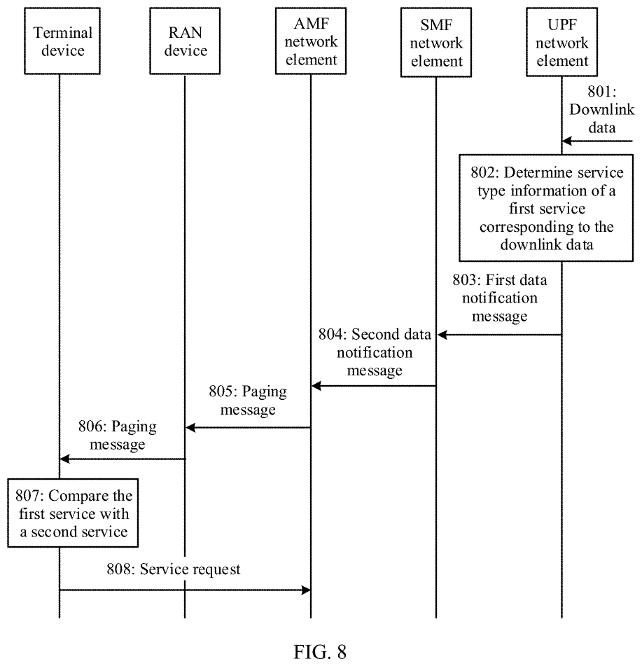

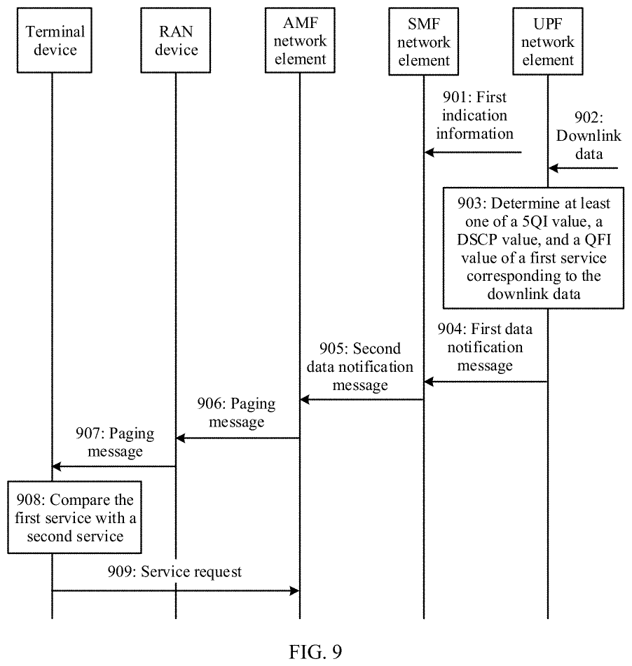

Based on the network architectures shown in FIG. 1 and FIG. 2, FIG. 9 is a schematic flowchart of still another communication method according to an embodiment of the present invention. As shown in FIG. 9, the communication method may include the following steps.

901: An SMF network element receives first indication information.

The SMF network element may receive the first indication information. The first indication information may be obtained by the SMF network element from a PCF network element. The first indication information may be obtained by the PCF network element from a UDR network element during session establishment or session modification, or may be generated by the PCF network element. Alternatively, the first indication information may be obtained by the SMF network element from a UDM network element.

902: A UPF network element receives downlink data.

903: The UPF network element determines at least one of a 5QI value, a DSCP value, and a QFI value of a first service corresponding to the downlink data.

After receiving the downlink data from a DN, the UPF network element may obtain the DSCP value from a header of a data packet, or may obtain the QFI value or the 5QI value from a received data flow through mapping according to an existing packet detection rule. For detailed descriptions, refer to the foregoing corresponding descriptions.

904: The UPF network element sends, to the SMF network element, a first data notification message that carries the at least one of the 5QI value, the DSCP value, and the QFI value of the first service.

After determining the at least one of the 5QI value, the DSCP value, and the QFI value of the first service corresponding to the downlink data, the UPF network element may send, to the SMF network element, the first data notification message that carries the at least one of the 5QI value, the DSCP value, and the QFI value of the first service. For detailed descriptions, refer to the foregoing corresponding descriptions.

905: The SMF network element sends, to an AMF network element, a second data notification message that carries the at least one of the 5QI value, the DSCP value, and the QFI value of the first service.

After receiving the first data notification message from the UPF network element, the SMF network element may send, to the AMF network element based on the first indication information, the second data notification message that carries the at least one of the 5QI value, the DSCP value, and the QFI value of the first service. For detailed descriptions, refer to the foregoing corresponding descriptions.

906: The AMF network element sends, to a RAN device, a paging message that carries the at least one of the 5QI value, the DSCP value, and the QFI value of the first service.

After receiving the second data notification message from the SMF network element, the AMF network element may send, to the RAN device, the paging message that carries the at least one of the 5QI value, the DSCP value, and the QFI value of the first service, in other words, the paging message carries the at least one of the 5QI value, the DSCP value, and the QFI value of the first service.

Optionally, the method further includes: The AMF network element may obtain subscription information of a terminal device from the UDM network element, and the AMF network element may determine, based on the subscription information of the terminal device, whether to include the at least one of the 5QI value, the DSCP value, and the QFI value of the first service in the paging message. For detailed descriptions, refer to the foregoing corresponding descriptions.

Optionally, the AMF network element may indicate, in the paging message, the RAN device to include the at least one of the 5QI value, the DSCP value, and the QFI value of the first service in the paging message.

Optionally, after receiving the second data notification message from the SMF network element, the AMF network element may first determine whether one of at least two USIMs supported by the terminal device is in a connected state. For detailed descriptions, refer to step 504.

907: The RAN device sends, to the terminal device, a paging message that carries the at least one of the 5QI value, the DSCP value, and the QFI value of the first service.

After receiving the paging message from the AMF network element, the RAN device may send, to the terminal device, the paging message that carries the at least one of the 5QI value, the DSCP value, and the QFI value of the first service. The RAN device may directly forward the paging message received from the AMF network element to the terminal device, or may include the at least one of the 5QI value, the DSCP value, and the QFI value of the first service in the paging message based on indication information of the AMF network element.

908: The terminal device compares the first service with a second service.

For detailed descriptions, refer to the foregoing corresponding descriptions.

909: The terminal device sends a service request to the AMF network element through the RAN device.

For detailed descriptions, refer to the foregoing corresponding descriptions.

In the communication method described in FIG. 9, the UPF network element may include, based on the indication information sent by the SMF network element, service information of a service in the first data notification message sent to the SMF network element, and the second data notification message sent by the SMF network element to the AMF network element carries the service information of the service, so that the AMF network element can include the service information of the service in the paging message. Therefore, the terminal device may determine, based on the service information, of the service, carried in the paging message and service information of a service of the USIM currently in the connected state on the terminal device, whether to respond to the paging message instead of blindly responding to the paging message, to avoid suspending the service of the USIM currently in the connected state on the terminal device once the paging message is received.

In another example, in step 903, the UPF network element determines the QFI value of the first service corresponding to the downlink data. In step 904, the first data notification message includes the QFI value of the first service, and the SMF network element further determines the 5QI value of the first service based on the QFI value of the first service. In step 905, the first data notification message includes the 5QI value of the first service. In step 906 and step 907, the paging message includes the 5QI value of the first service.

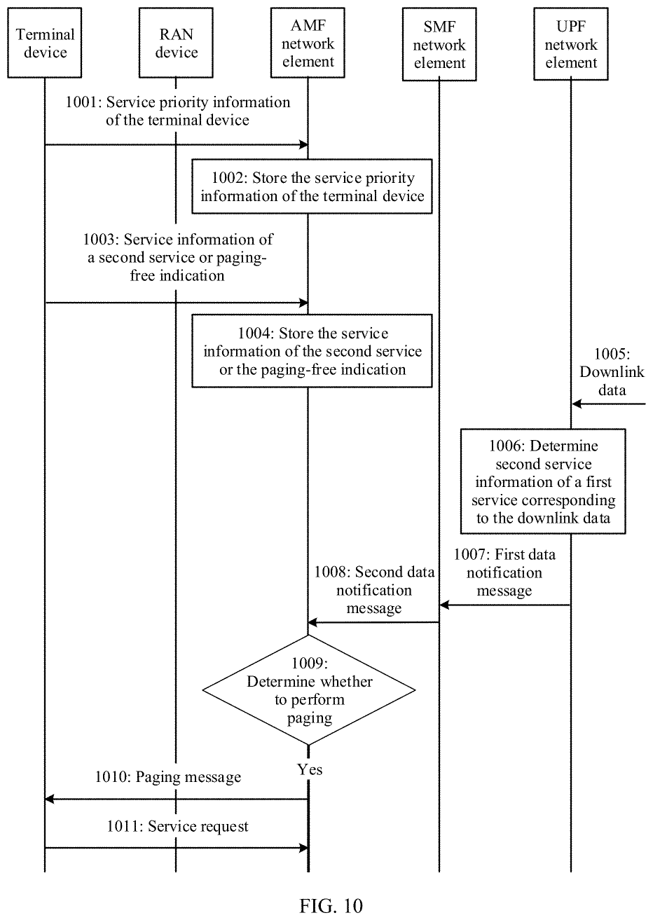

Based on the network architectures shown in FIG. 1 and FIG. 2, FIG. 10 is a schematic flowchart of still another communication method according to an embodiment of the present invention. As shown in FIG. 10, the communication method may include the following steps.

1001: A terminal device sends service priority information of the terminal device to an AMF network element through a RAN device.

For detailed descriptions, refer to the foregoing corresponding descriptions.

1002: The AMF network element stores the service priority information of the terminal device.

After receiving the service priority information of the terminal device from the terminal device, the AMF network element may store the service priority information of the terminal device for subsequent invocation.

1003: The terminal device sends service information of a second service or a paging-restricted indication to the AMF network element through the RAN device.

When one of at least two USIMs of the terminal device is in a connected state, the terminal device may send the service information of the second service or the paging-restricted indication to the AMF network element through the RAN device, where the second service is a service of the USIM currently in the connected state.

1004: The AMF network element stores the service information of the second service or the paging-restricted indication.

After receiving the service information of the second service or the paging-restricted indication from the terminal device, the AMF network element may store the service information of the second service or the paging-restricted indication for subsequent invocation.

1005: A UPF network element receives downlink data.

1006: The UPF network element determines second service information of a first service corresponding to the downlink data.

For detailed descriptions, refer to the foregoing corresponding descriptions.

1007: The UPF network element sends, to an SMF network element, a first data notification message that carries the second service information of the first service.

For detailed descriptions, refer to the foregoing corresponding descriptions.

1008: The SMF network element sends, to the AMF network element, a second data notification message that carries the second service information of the first service.

For detailed descriptions, refer to the foregoing corresponding descriptions.

1009: The AMF network element determines whether to perform paging, and performs step 1010 when determining to perform paging.

After receiving the second data notification message from the SMF network element, the AMF network element may determine whether to perform paging. Specifically, determining may be performed based on the service priority information of the terminal device, the second service information of the first service, and the service information of the second service. For detailed descriptions, refer to the foregoing corresponding descriptions. When it is determined to perform paging, step 1010 is performed. Alternatively, determining may be performed based on the paging-restricted indication. For detailed descriptions, refer to the foregoing corresponding descriptions.

1010: The AMF network element sends, to the terminal device through the RAN device, a paging message that carries first service information of the first service.

For detailed descriptions, refer to the foregoing corresponding descriptions.

1011: The terminal device sends a service request to the AMF network element through the RAN device.

For detailed descriptions, refer to the foregoing corresponding descriptions.

In the communication method described in FIG. 10, the terminal device may send the paging-restricted indication to the AMF network element, so that the AMF network element may determine, based on the paging-restricted indication, not to send the paging message to a first USIM of the terminal device. Alternatively, the terminal device may send the service priority information of the terminal device and the service information of the second service to the AMF network element, so that the AMF network element may determine, based on the service priority information of the terminal device and the service information of the second service, whether to include service information of a service in the paging message.

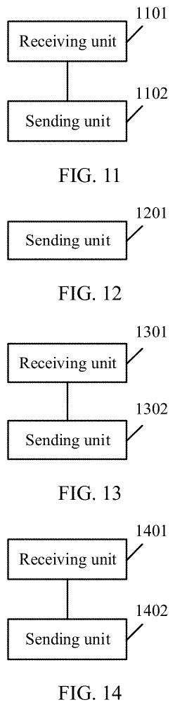

Based on the network architectures shown in FIG. 1 and FIG. 2, FIG. 11 is a schematic diagram of a structure of a terminal device according to an embodiment of the present invention. The terminal device has at least two USIMs, and the terminal device may be configured to perform related steps of the terminal device in the foregoing method embodiments.

As shown in FIG. 11, the terminal device may include:

a receiving unit 1101, configured to receive a paging message from an AMF network element, where the paging message corresponds to a first USIM in at least two USIMs of the terminal device, and the paging message carries first service information of a first service; and

a sending unit 1102, configured to send a response message of the paging message to the AMF network element based on the first service information of the first service and service information of a second service, where the second service is a current service of a second USIM of the terminal device, and the second USIM is in a connected state.

In an embodiment, the first service information of the first service may include:

a priority of the first service;

service type information of the first service; or

at least one of a 5QI, a DSCP, and a QFI of the first service.

In an embodiment, the sending unit 1102 is specifically configured to: when determining, based on the first service information of the first service and the service information of the second service, that the priority of the first service is higher than a priority of the second service, send the response message of the paging message to the AMF network element.

In an embodiment, when the first service information of the first service does not include the priority of the first service, and the service information of the second service includes the priority of the second service, that the sending unit 1102 determines, based on the first service information of the first service and the service information of the second service, that the priority of the first service is higher than a priority of the second service includes:

obtaining the priority of the first service based on the first service information of the first service; and

determining that the priority of the first service is higher than the priority of the second service.

In an embodiment, when the first service information of the first service includes the at least one of the 5QI, the DSCP, and the QFI of the first service, that the sending unit 1102 obtains the priority of the first service based on the first service information of the first service includes:

obtaining the service type information of the first service based on the first service information of the first service; and

obtaining the priority of the first service based on the service type information of the first service.

In an embodiment, the sending unit 1102 is further configured to:

send indication information to the AMF network element, where the indication information is used to indicate to include service information of a service in the paging message sent to the terminal device; or

send USIM capability information of the terminal device to the AMF network element, where the USIM capability information is used to indicate that the terminal device supports at least two USIMs.

For more detailed descriptions of the receiving unit 1101 and the sending unit 1102, directly refer to related descriptions of the terminal device in the method embodiments. Details are not described herein again.

Based on the network architectures shown in FIG. 1 and FIG. 2, FIG. 12 is a schematic diagram of a structure of another terminal device according to an embodiment of the present invention. The terminal device may be configured to perform related steps of the terminal device in the foregoing method embodiments.

As shown in FIG. 12, the terminal device may include:

a sending unit 1201, configured to send service priority information of the terminal device to an AMF network element, where the service priority information of the terminal device is used to indicate a priority of a service.

In an embodiment, the sending unit 1201 is further configured to send service information of a second service to the AMF network element, where the second service is a current service of a second USIM in at least two USIMs of the terminal device, and the second USIM is in a connected state.

In an embodiment, when the current service of the second USIM includes at least two services, the second service is a service with a highest priority in the at least two services.

In an embodiment, the sending unit 1201 is further configured to send a paging-restricted indication to the AMF network element, where the paging-restricted indication is used to indicate not to send a paging message to a first USIM, and the first USIM is any USIM in an idle state in the at least two USIMs of the terminal device.

In an embodiment, the paging-restricted indication carries an identifier of the first USIM.

In an embodiment, that the sending unit 1201 sends a paging-restricted indication to the AMF network element includes:

when a second service has a highest priority in services supported by the terminal device, sending the paging-restricted indication to the AMF network element, where the second service is a current service of a second USIM in at least two USIMs of the terminal device, and the second USIM is in a connected state.

In an embodiment, the sending unit 1201 is further configured to: when the second service ends, send a paging-restricted cancellation indication to the AMF network element, where the paging-restricted cancellation indication is used to indicate to cancel the paging-restricted indication.

In an embodiment, the service information of the second service includes:

a priority of the second service;

service type information of the second service; or

at least one of a 5QI, a DSCP, and a QFI of the second service.

For more detailed descriptions of the sending unit 1201, directly refer to related descriptions of the terminal device in the method embodiments. Details are not described herein again.

Based on the network architectures shown in FIG. 1 and FIG. 2, FIG. 13 is a schematic diagram of a structure of a UPF network element according to an embodiment of the present invention. The UPF network element may be configured to perform related steps of the UPF network element in the foregoing method embodiments.

As shown in FIG. 13, the UPF network element may include:

a receiving unit 1301, configured to receive first indication information from an SMF network element, where the first indication information is used to indicate to include service information in a data notification message of a first USIM, or is used to indicate to include service information in a data notification message when to-be-sent downlink data for a first USIM is data of a specific service; and

a sending unit 1302, configured to send a first data notification message to the SMF network element based on the first indication information, where the first data notification message is used to notify that there is the to-be-sent downlink data for the first USIM, and the first data notification message carries second service information of a first service corresponding to the to-be-sent downlink data for the first USIM.

In an embodiment, the second service information of the first service includes:

a priority of the first service;

service type information of the first service; or

at least one of a 5QI, a DSCP, and a QFI of the first service.

For more detailed descriptions of the receiving unit 1301 and the sending unit 1302, refer to related descriptions of the UPF network element in the foregoing method embodiments. Details are not described herein again.

Based on the network architectures shown in FIG. 1 and FIG. 2, FIG. 14 is a schematic diagram of a structure of an SMF network element according to an embodiment of the present invention. The SMF network element may be configured to perform related steps of the SMF network element in the foregoing method embodiments.

As shown in FIG. 14, the SMF network element may include:

a receiving unit 1401, configured to receive a first data notification message from a UPF network element, where the first data notification message is used to notify that there is to-be-sent downlink data for a first USIM, and the first data notification message carries second service information of a first service corresponding to the to-be-sent downlink data for the first USIM; and

a sending unit 1402, configured to send a second data notification message to an AMF network element based on the first data notification message, where the second data notification message carries the second service information of the first service corresponding to the to-be-sent downlink data for the first USIM.

In an embodiment, the sending unit 1402 is further configured to send first indication information to the UPF network element, where the first indication information is used to indicate to include service information in a data notification message of the first USIM, or is used to indicate to include service information in a data notification message when the to-be-sent downlink data for the first USIM is data of a specific service.

In an embodiment, the receiving unit 1401 is further configured to receive the first indication information from a PCF network element or a UDM network element.

In an embodiment, the receiving unit 1401 is further configured to receive USIM capability information from the terminal device, where the USIM capability information is used to indicate that the terminal device supports at least two USIMs, and the first USIM is a USIM corresponding to the terminal device; and

that the sending unit 1402 sends first indication information to the UPF network element includes:

sending the first indication information to the UPF network element based on the USIM capability information of the terminal device.

In an embodiment, the second service information of the first service includes:

a priority of the first service;

service type information of the first service; or

at least one of a 5QI, a DSCP, and a QFI of the first service.

For more detailed descriptions of the receiving unit 1401 and the sending unit 1402, refer to related descriptions of the SMF network element in the foregoing method embodiments. Details are not described herein again.

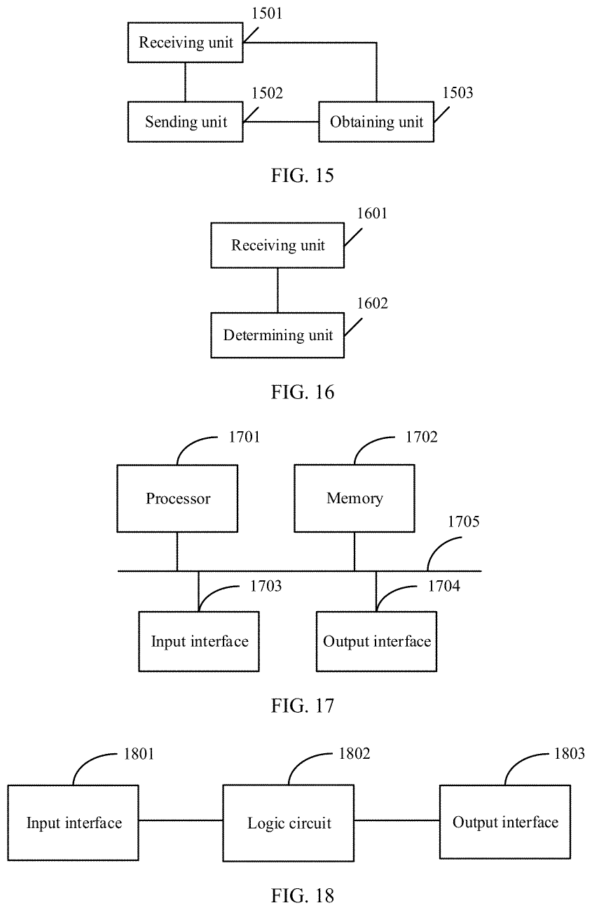

Based on the network architectures shown in FIG. 1 and FIG. 2, FIG. 15 is a schematic diagram of a structure of an AMF network element according to an embodiment of the present invention. The AMF network element may be configured to perform related steps of the AMF network element in the foregoing method embodiments.

As shown in FIG. 15, the AMF network element may include:

a receiving unit 1501, configured to receive a second data notification message from an SMF network element, where the second data notification message carries second service information of a first service corresponding to to-be-sent downlink data for a first USIM, and the first USIM is a USIM corresponding to a terminal device; and

a sending unit 1502, configured to send a paging message to the terminal device based on the second data notification message, where the paging message is used to page a user corresponding to the first USIM, and the paging message carries first service information of the first service.

In an embodiment, the AMF network element may further include:

an obtaining unit 1503, configured to: when the first service information of the first service is different from the second service information of the first service, obtain the first service information of the first service based on the second service information of the first service.

In an embodiment, the second service information of the first service does not include a priority of the first service, the first service information of the first service includes the priority of the first service, and the obtaining unit 1503 is specifically configured to:

receive service priority information of the terminal device; and

obtain the first service information of the first service based on the second service information of the first service and the service priority information of the terminal device.

In an embodiment, the receiving unit 1501 is further configured to receive service information of a second service from the terminal device, where the second service is a current service of a second USIM of the terminal device, and the second USIM is in a connected state.

that a sending unit 1502 sends a paging message to the terminal device includes:

sending the paging message to the terminal device based on the second service information of the first service and the service information of the second service.

In an embodiment, that the sending unit 1502 sends the paging message to the terminal device based on the second service information of the first service and the service information of the second service includes:

sending the paging message to the terminal device when determining, based on the second service information of the first service and the service information of the second service, that the priority of the first service is higher than a priority of the second service.

In an embodiment, the receiving unit 1501 is further configured to receive the service priority information of the terminal device; and

that the sending unit 1502 determines, based on the second service information of the first service and the service information of the second service, that the priority of the first service is higher than a priority of the second service includes:

determining, based on the service priority information of the terminal device, the second service information of the first service, and the service information of the second service, that the priority of the first service is higher than the priority of the second service.

In an embodiment, the receiving unit 1501 is further configured to receive indication information from the terminal device, where the indication information is used to indicate to include service information of a service in the paging message that corresponds to the first USIM and is sent to the terminal device; and

that a sending unit 1502 sends a paging message to the terminal device includes:

sending the paging message to the terminal device based on the indication information.

In an embodiment, the receiving unit 1501 is further configured to receive USIM capability information from the terminal device, where the USIM capability information is used to indicate that the terminal device supports at least two USIMs; and

that a sending unit 1502 sends a paging message to the terminal device includes:

sending the paging message to the terminal device based on the USIM capability information.

In an embodiment, the second service information of the first service includes:

a priority of the first service;

service type information of the first service; or

at least one of a 5QI, a DSCP, and a QFI of the first service.

In an embodiment, the first service information of the first service includes:

the priority of the first service;

the service type information of the first service; or

the at least one of the 5QI, the DSCP, and the QFI of the first service.

For more detailed descriptions of the receiving unit 1501, the sending unit 1502, and the obtaining unit 1503, refer to related descriptions of the AMF network element in the foregoing method embodiments. Details are not described herein again.

Based on the network architectures shown in FIG. 1 and FIG. 2, FIG. 16 is a schematic diagram of a structure of another AMF network element according to an embodiment of the present invention. The AMF network element may be configured to perform related steps of the AMF network element in the foregoing method embodiments.

As shown in FIG. 16, the AMF network element may include:

a receiving unit 1601, configured to receive a second data notification message from an SMF network element, where the second data notification message carries second service information of a first service corresponding to to-be-sent downlink data for a first USIM, and the first USIM is a USIM corresponding to a terminal device.

In an embodiment, the receiving unit 1601 is further configured to receive a paging-restricted indication from the terminal device, where the paging-restricted indication is used to indicate not to send a paging message to the first USIM, and the first USIM is in an idle state.

The AMF network element may further include:

a determining unit 1602, configured to determine, based on the paging-restricted indication, not to send the paging message to the first USIM.

For more detailed descriptions of the receiving unit 1601 and the determining unit 1602, refer to related descriptions of the AMF network element in the foregoing method embodiments. Details are not described herein again.

Based on the network architectures shown in FIG. 1 and FIG. 2, FIG. 17 is a schematic diagram of a structure of a communication device according to an embodiment of the present invention. As shown in FIG. 17, the communication device may include a processor 1701 and a memory 1702. Further, the communication device may further include an input interface 1703, an output interface 1704, and a bus 1705.

The memory 1702 may exist independently, and may be connected to the processor 1701 through the bus 1705. The memory 1702 may alternatively be integrated with the processor 1701. The bus 1705 is configured to implement connections among these components.

In an embodiment, the communication device may be a terminal device or located in the terminal device. When computer program instructions stored in the memory 1702 are executed, the processor 1701 is configured to perform the steps of the terminal device in the foregoing method embodiments.

For example, when the computer program instructions stored in the memory 1702 are executed, the processor 1701 is configured to control the receiving unit 1101 and the sending unit 1102 to perform the operations performed in the foregoing embodiments, the input interface 1703 is configured to perform the operations performed by the receiving unit 1101 in the foregoing embodiments, and the output interface 1704 is configured to perform the operations performed by the sending unit 1102 in the foregoing embodiments. The terminal device may be further configured to perform various methods performed by the terminal device in the foregoing method embodiments. Details are not described again.

For another example, when the computer program instructions stored in the memory 1702 are executed, the processor 1701 is configured to perform the operations performed by the sending unit 1201 in the foregoing embodiments, and the output interface 1704 is configured to perform the operations performed by the sending unit 1201 in the foregoing embodiments. The terminal device may be further configured to perform various methods performed by the terminal device in the foregoing method embodiments. Details are not described again.

In another embodiment, the communication device may be a UPF network element or located in the UPF network element. When the computer program instructions stored in the memory 1702 are executed, the processor 1701 is configured to perform the steps of the UPF network element in the foregoing method embodiments.

For example, when the computer program instructions stored in the memory 1702 are executed, the processor 1701 is configured to control the receiving unit 1301 and the sending unit 1302 to perform the operations performed in the foregoing embodiments, the input interface 1703 is configured to perform the operations performed by the receiving unit 1301 in the foregoing embodiments, and the output interface 1704 is configured to perform the operations performed by the sending unit 1302 in the foregoing embodiments. The UPF network element may be further configured to perform various methods performed by the UPF network element in the foregoing method embodiments. Details are not described again.

In still another embodiment, the communication device may be an SMF network element or located in the SMF network element. When the computer program instructions stored in the memory 1702 are executed, the processor 1701 is configured to perform the steps of the SMF network element in the foregoing method embodiments.

For example, when the computer program instructions stored in the memory 1702 are executed, the processor 1701 is configured to control the receiving unit 1401 and the sending unit 1402 to perform the operations performed in the foregoing embodiments, the input interface 1703 is configured to perform the operations performed by the receiving unit 1401 in the foregoing embodiments, and the output interface 1704 is configured to perform the operations performed by the sending unit 1402 in the foregoing embodiments. The SMF network element may be further configured to perform various methods performed by the SMF network element in the foregoing method embodiments. Details are not described again.

In yet another embodiment, the communication device may be an AMF network element or located in the AMF network element. When the computer program instructions stored in the memory 1702 are executed, the processor 1701 is configured to perform the steps of the AMF network element in the foregoing method embodiments.

For example, when the computer program instructions stored in the memory 1702 are executed, the processor 1701 is configured to control the receiving unit 1501 and the sending unit 1502 to perform the operations performed in the foregoing embodiments, the processor 1701 is further configured to control the obtaining unit 1503 to perform the operations performed in the foregoing embodiments, the input interface 1703 is configured to perform the operations performed by the receiving unit 1501 in the foregoing embodiments, and the output interface 1704 is configured to perform the operations performed by the sending unit 1502 in the foregoing embodiments. The AMF network element may be further configured to perform various methods performed by the AMF network element in the foregoing method embodiments. Details are not described again.

For another example, when the computer program instructions stored in the memory 1702 are executed, the processor 1701 is configured to control the receiving unit 1601 to perform the operations performed in the foregoing embodiments, the processor 1701 is further configured to control the determining unit 1602 to perform the operations performed in the foregoing embodiments, and the input interface 1703 is configured to perform the operations performed by the receiving unit 1601 in the foregoing embodiments. The AMF network element may be further configured to perform various methods performed by the AMF network element in the foregoing method embodiments. Details are not described again.

Based on the network architectures shown in FIG. 1 and FIG. 2, FIG. 18 is a schematic diagram of a structure of another communication device according to an embodiment of the present invention. As shown in FIG. 18, the communication device may include an input interface 1801, a logic circuit 1802, and an output interface 1803. The input interface 1801 is connected to the output interface 1803 through the logic circuit 1802. The input interface 1801 is configured to receive information from another communication device, and the output interface 1803 is configured to output, schedule, or send information to the another communication device. The logic circuit 1802 is configured to perform operations other than operations of the input interface 1801 and the output interface 1803, for example, implement functions implemented by the processor 1701 in the foregoing embodiments. The communication device may be a terminal device, a UPF network element, an SMF network element, or an AMF network element. For more detailed descriptions of the input interface 1801, the logic circuit 1802, and the output interface 1803, directly refer to related descriptions of the terminal device, the UPF network element, the SMF network element, or the AMF network element in the foregoing method embodiments. Details are not described herein again.

An embodiment of the present invention further discloses a computer-readable storage medium. The computer-readable storage medium stores instructions. When the instructions are executed, the methods in the foregoing method embodiments are performed.

An embodiment of the present invention further discloses a computer program product including instructions. When the instructions are executed, the methods in the foregoing method embodiments are performed.

An embodiment of the present invention further discloses a communication system. The communication system includes a UPF network element, an SMF network element, and an AMF network element. Further, the system may further include a terminal device. For actions of the devices in the system, refer to related descriptions in any one of the communication methods shown in FIG. 5 to FIG. 10. Details are not described again.

The objectives, technical solutions, and beneficial effects of the present invention are further described in detail in the foregoing specific implementations. It should be understood that the foregoing descriptions are merely specific implementations of the present invention, but are not intended to limit the protection scope of the present invention. Any modification, equivalent replacement, or improvement made based on the technical solutions of the present invention shall fall within the protection scope of the present invention.

What is claimed is:

1. A communication method by a terminal device, comprising:
establishing a communication with at least two universal subscriber identity modules (USIMs), and
sending a paging-restricted indication to an access and mobility management function (AMF) network element to indicate to the AMF network element to not to send a paging message to a first USIM and wherein the first USIM is an idle state.

2. The method according to claim 1, further comprising:
sending, by the terminal device, service priority information of the terminal device to the AMF network element, wherein the service priority information indicates a priority of a service.

3. The method according to claim 2, further comprising:
sending, by the terminal device, service information of a second service to the AMF network element, wherein the second service is a current service of a second USIM in at least two USIMs of the terminal device, and the second USIM is in a connected state.

4. The method according to claim 3, wherein the current service comprises at least two services, the second service is a service with a highest priority in the at least two services.

5. The method according to claim 1, wherein the paging-restricted indication carries an identifier of the first USIM.

6. The method according to claim 1, wherein the sending, by the terminal device, a paging-restricted indication to the AMF network element comprises:
in case that a second service has a highest priority in services supported by the terminal device, sending, by the terminal device, the paging-restricted indication to the AMF network element, wherein the second service is a current service of a second USIM in at least two USIMs of the terminal device, and the second USIM is in a connected state.

7. The method according to claim 6, further comprising:
in case that the second service ends, sending, by the terminal device, a paging-restricted cancellation indication to the AMF network element, wherein the paging-restricted cancellation indication is used to indicate to cancel the paging-restricted indication.

8. The method according to claim 3, wherein the service information of the second service comprises:
a priority of the second service;
service type information of the second service; or
at least one of a 5G quality of service flow identifier (5QI), a differentiated services code point (DSCP), and a quality of service flow identifier (QFI) of the second service.

9. The method according to claim 8, wherein the service type information of the first service is data, a voice, a video, or an SMS message.

10. A communication method, comprising:
receiving, by an access and mobility management function (AMF) network element, a second data notification message from a session management function (SMF) network element, wherein the second data notification message carries second service information of a first service corresponding to to-be-sent downlink data for a first universal subscriber identity module (USIM), and the first USIM is a USIM corresponding to a terminal device;
receiving, by the AMF network element, a paging-restricted indication from the terminal device, wherein the paging-restricted indication is used to indicate not to send a paging message to the first USIM, and the first USIM is in an idle state; and
determining, by the AMF network element based on the paging-restricted indication, not to send the paging message to the first USIM.

11. The method according to claim 10, wherein the second service information of the first service comprises:
a priority of the first service;
service type information of the first service; or
at least one of a 5G quality of service flow identifier (5QI), a differentiated services code point (DSCP), and a quality of service flow identifier (QFI) of the first service.

12. The method according to claim 11, wherein the service type information of the first service is data, a voice, a video, or an SMS message.

13. A communication device, comprising:
a non-transitory memory storage comprising instructions; and
one or more processors in communication with the memory storage, wherein the one or more processors execute the instructions to:
send a paging-restricted indication to an access and mobility management function (AMF) network element, wherein the paging-restricted indication is used to indicate not to send a paging message to a first universal subscriber identity module (USIM), and the first USIM is any USIM in an idle state in the at least two USIMs of a terminal device.

14. The device according to claim 13, wherein the one or more processors are configured to execute the instructions to further:
send service priority information of the terminal device to the AMF network element, wherein the service priority information indicates a priority of a service.

15. The device according to claim 14, wherein the one or more processors are configured to execute the instructions to further:
send service information of a second service to the AMF network element, wherein the second service is a current service of a second USIM in at least two USIMs of the terminal device, and the second USIM is in a connected state.

16. The device according to claim 15, wherein the current service comprises at least two services, the second service is a service with a highest priority in the at least two services.

17. The device according to claim 13, wherein the paging-restricted indication carries an identifier of the first USIM.

18. The device according to claim 15, wherein the service information of the second service comprises:
a priority of the second service;
service type information of the second service; or
at least one of a 5G quality of service flow identifier (5QI), a differentiated services code point (DSCP), and a quality of service flow identifier (QFI) of the second service.

19. A communication device, comprising:
a non-transitory memory storage comprising instructions; and
one or more processors in communication with the memory storage, wherein the one or more processors execute the instructions to:
receive a second data notification message from a session management function (SMF) network element, wherein the second data notification message carries second service information of a first service corresponding to to-be-sent downlink data for a first universal subscriber identity module (USIM), and the first USIM is a USIM corresponding to a terminal device;
receive a paging-restricted indication from the terminal device, wherein the paging-restricted indication is used to indicate not to send a paging message to the first USIM, and the first USIM is in an idle state; and
determine, based on the paging-restricted indication, not to send the paging message to the first USIM.

20. The device according to claim 19, wherein the second service information of the first service comprises:
a priority of the first service;
service type information of the first service; or
at least one of a 5G quality of service flow identifier (5QI), a differentiated services code point (DSCP), and a quality of service flow identifier (QFI) of the first service.
